(19) United States
(12) Patent Application Publication
(10) Pub. No.: US 2011/0181693 A1
(43) Pub. Date: Jul. 28, 2011

(54) METHOD AND APPARATUS FOR GENERATING DATA STREAM FOR PROVIDING 3-DIMENSIONAL MULTIMEDIA SERVICE, AND METHOD AND APPARATUS FOR RECEIVING THE DATA STREAM

(75) Inventors: Jae-jun LEE, Suwon-si (KR); Yong-seok JANG, Hwaseong-si (KR); Yong-tae KIM, Seoul (KR); Hong-seok PARK, Anyang-si (KR); Kil-soo JUNG, Osan-si (KR); Dae-jong LEE, Suwon-si (KR)

(73) Assignee: SAMSUNG ELECTRONICS CO., LTD., Suwon-si (KR)

(21) Appl. No.: 13/016,214

(22) Filed: Jan. 28, 2011

Related U.S. Application Data
(60) Provisional application No. 61/310,083, filed on Mar. 3, 2010.
(60) Provisional application No. 61/299,132, filed on Jan. 28, 2010.

(30) Foreign Application Priority Data
Jun. 3, 2010 (KR) 10-2010-0052364

(51) Int. Cl. H04N 13/00

(52) U.S. Cl. 348/43; 348/E13.001

(57) ABSTRACT

A method and apparatus for generating a data stream for providing a three-dimensional (3D) multimedia service and a method and apparatus for receiving the data stream are provided. The generating method includes: generating at least one elementary stream (ES) including video data of each view from a program for providing a two-dimensional (2D) or 3D multimedia service; generating program map table (PMT) information about the program, including reference information about the at least one ES and 3D additional information for identifying and reproducing the video data of each view; and generating at least one transport stream (TS) by multiplexing packetized elementary stream (PES) packets generated by packetizing the at least one ES, and the PMT information.

### CROSS-REFERENCE TO RELATED PATENT APPLICATIONS

This application claims the benefit of U.S. Provisional Application Nos. 61/299,132, filed on Jan. 28, 2010, and 61/310,083, filed on Mar. 3, 2010, in the US Patent and Trademark Office, and claims priority from Korean Patent Application No. 10-2010-0052364, filed on Jun. 3, 2010 in the Korean Intellectual Property Office, the disclosures of which are incorporated herein in their entireties by reference.

### BACKGROUND

1. Field

Apparatuses and methods consistent with exemplary embodiments relate to transmitting and receiving a data stream for providing a three-dimensional (3D) multimedia service.

2. Description of the Related Art

In a Moving Picture Experts Group (MPEG) transport stream (TS) based digital broadcasting method, a transmission terminal inserts uncompressed video data and uncompressed audio data into respective elementary streams (ESs), multiplexes each of the ESs to generate a TS, and transmits the TS via a channel.

The TS includes program specification information (PSI) together with the ESs. The PSI representatively includes program association table (PAT) information and program map table (PMT) information. The PMT information providing single-program information describes a Packet Identifier (PID) for each ES, and the PAT information describes a PID for each piece of PMT information.

A reception terminal receives a TS via a channel and extracts an ES from the TS through a process that is the reverse of the process performed in the transmission terminal. Digital contents contained in the ES are restored and reproduced by a display device.

### SUMMARY

According to an aspect of an exemplary embodiment, there is provided a method of generating a data stream for providing a 3D multimedia service, the method including: generating at least one ES including video data of each view from a program for providing at least one of a two-dimensional (2D) multimedia service and a 3D multimedia service; generating program map table (PMT) information about the program, including reference information about the at least one ES and 3D additional information for identifying and reproducing the video data of each view; and generating at least one transport stream (TS) by multiplexing packetized elementary stream (PES) packets generated by packetizing the at least one ES, and the PMT information.

The generating the PMT information may include: inserting 3D additional information about main video data, which is inserted in a main ES from among the at least one ES, into descriptor information for the main ES in the PMT information; and inserting at least one of 3D additional information and reference information about sub video data included in a sub ES from among the at least one ESs, into the descriptor information for the main ES, wherein the main video data and the sub video data may be a combination of video data of first and second views, respectively.

The 3D additional information about the main video data may further include reference information about the sub ES, including at least one of stream type information of the sub ES and packet identifier (PID) information of the sub ES.

The inserting the at least one of 3D additional information and reference information about sub video data may include setting stream type information of the sub ES from the reference information about the sub ES to a value of an auxiliary video stream assigned by an MPEG system.

The inserting the at least one of 3D additional information and reference information about sub video data may include, if a number of sub ESs is two or more in the at least one ES, setting at least one of the 3D additional information and the reference information according to each sub ES.

The 3D additional information about the main video data may include at least one of image format information of the main video data, view arrangement order information of an image format of the main video data, and information about a number of sub ESs.

The 3D additional information about the sub video data may include at least one of image format information of the sub video data of the sub ES, display order information of the main video data and the sub video data, 3D effect adjustment information for a child or an adult, and sub video index information indicating the sub video data from the video data of each view.

The generating the PMT information may include sequentially inserting ES information, which includes stream type information, PID information, and video stream descriptor information of a respective ES, into the PMT information, according to the at least one ES.

The generating the PMT information may further include inserting, into the PMT information, 3D video descriptor information, which includes 3D additional information about the main video data included in a main ES from the at least one ES.

The inserting the 3D video descriptor information may include inserting information about a number of the at least one ES and image format information of the at least one ES into the 3D video descriptor information.

If the number of the at least one ES is one, the image format information of the at least one ES may indicate a 3D composite format in which main view video data and sub view video data from the video data of each view are composed, and if the number of the at least one ES is two or above, the image format information of the at least one ES may indicate a 3D image format in which the video data of each view includes the main view video data and at least one of depth information of the sub view video data with respect to the main view video data, parallax information of the sub view video data with respect to the main view video data, and the sub view video data.

The generating the PMT information may include inserting codec information about a method of encoding and decoding sub video data included in the sub ES, into the ES information about the sub ES from the at least one ES.

The generating the PMT information may include inserting sub ES video descriptor information including at least one of the 3D additional information and reference information into the ES information about the sub ES from the at least one ES.

The inserting the sub ES video descriptor information may include inserting information indicating whether depth information or parallax information of the sub view video data with respect to the main view video data is simultaneously transmitted with the sub view video data, and 3D hybrid format information, into the sub ES video descriptor information.

The inserting the sub ES video descriptor information may include inserting information indicating whether the sub video data is at least one of the sub view video data and depth or parallax information of the sub view video data with respect to the sub view video data, into the sub ES video descriptor information.

The inserting the sub ES video descriptor information may further include, if the sub video data is the sub view video data, inserting a sub view video parameter including at least one of PID information about the main view ES related to the sub view ES, and information indicating whether the sub video data is left view video data or right view video data, into the sub ES video descriptor information.

The sub view video parameter may include information indicating an image size of the sub view video data so as to adjust image sizes of the main view video data and the sub view video data to be the same while reproducing the 3D multimedia service.

The inserting the ES information may include setting the stream type information from the ES information about the sub ES in the at least one ES to a value of an auxiliary video stream assigned by an MPEG system.

The inserting the sub ES video descriptor information may include, if the number of sub ESs is two or more, setting the sub ES video descriptor information according to each sub ES.

The generating the PMT information may include inserting 3D notice descriptor information indicating whether the 3D video data is included in the at least one TS, into the PMT information.

The 3D notice descriptor information may include at least one of information indicating whether a 3D notice indicating icon indicating that the 3D video data is included in a current ES exists, 2D/3D mode switch information indicating whether mode information different from current mode information of current PMT information is included in following PMT information after the current PMT information, switching time stamp information indicating a point of time when a 2D mode and a 3D mode are switched, and text information including a message to be displayed on a screen when the 2D mode and the 3D mode are switched.

The generating the PMT information may include further inserting 2D/3D transmission information including at least one of 2D/3D mode information indicating whether any one of the 2D video data, the 3D video data, and combined data of the 2D and 3D video data is included in a current ES, and 2D/3D mode switch information indicating whether the 2D/3D mode information of current PMT information is switched in following PMT information after the current PMT information, into the PMT information.

The generating the PMT information may include, if at least one of sizes and aspect ratios of main view video data and sub view video data from the video data of each view are different, inserting aspect ratio descriptor information including cropping offset information about a method of adjusting regions for displaying the main view video data and the sub view video data during 3D reproduction, into the PMT information.

The method may further include transmitting the at least one TS after synchronizing the at least one TS with a channel.

According to an aspect of another exemplary embodiment, there is provided a method of receiving a data stream for providing a 3D multimedia service, the method including: receiving at least one TS about a program providing a 2D multimedia service or a 3D multimedia service; extracting PES packets about the program and PMT information about the program by demultiplexing the at least one TS; extracting reference information about at least one ES including video data of each view from the program, and 3D additional information for identifying and reproducing the video data of each view, from the PMT information; and restoring the at least one ES by using the extracted reference information about the at least one ES from among ESs extracted by depacketizing the PES packets, and extracting the video data of each view from the at least one ES.

The method may further include reproducing the extracted video data of each view in 3D by using at least one of the 3D additional information and reference information.

The extracting the reference information and the 3D additional information from the PMT information may include: extracting at least one of reference information about a main ES from among the at least one ES, and 3D additional information about main video data included in the main ES from descriptor information for the main ES, from the PMT information; and extracting at least one of reference information about a sub ES from among the at least one ES, and 3D additional information about sub video data included in the sub ES from the descriptor information for the main ES, wherein the main video data and the sub video data may be a combination of the video data of first and second views, respectively.

The extracting the 3D additional information and the reference information about the sub video data may include, if the number of the sub ESs is two or more, extracting at least one of the 3D additional information and the reference information according to each sub ES.

The extracting the reference information and the 3D additional information from the PMT information may include sequentially extracting ES information, which includes stream type information of a respective ES, and video stream descriptor information including at least one of reference information including PID information and the 3D additional information, from the PMT information, according to the at least one ES.

The extracting the reference information and the 3D additional information from the PMT information may further include extracting 3D video descriptor information, which includes at least one of reference information and 3D additional information about the video data of each view, from the ES information about the main view ES including the main view video data from among the video data of each view in the at least one ES.

The extracting the reference information and the 3D additional information from the PMT information may include extracting sub ES video descriptor information including at least one of the reference information and the 3D additional information from the ES information about the sub ES from the at least one ES.

In the extracting the ES information, the stream type information from the ES information about the sub ES in the at least one ES may be set to a value of an auxiliary video stream assigned by a Moving Picture Experts Group (MPEG) system.

The extracting the reference information and the 3D additional information from the PMT information may include extracting 3D notice descriptor information indicating whether the 3D video data is included in the at least one TS, from the PMT information.

The extracting the 3D additional information and the reference information from the PMT information may include extracting at least one of 2D/3D mode information and 2D/3D mode switch information from the PMT information.

The extracting the 3D additional information and the reference information from the PMT information may include extracting aspect ratio descriptor information including cropping offset information from the PMT information.

The reproducing may include: restoring main view video data and sub view video data of 3D video of the 3D multimedia service; and reproducing the main view video data and the sub view video data by converting formats of the main view video data and the sub view video data into 3D reproduction formats so as to be reproducible by a 3D display device, by using at least one of the reference information and the 3D additional information.

The reproducing may include: restoring first view video data, which is one of main view video data of 3D video of the 3D multimedia service and 2D video data, and second view video data, which includes sub view video data of the 3D video and at least one of difference information, depth information, and parallax information between the main view video data and the sub view video data; and reproducing the first and second view video data by converting formats of the first and second view video data into 3D reproduction formats so as to be reproducible by a 3D display device, by using at least one of the reference information and the 3D additional information.

The reproducing may include: restoring first view video data constituting 3D composite format data in which main view video data and sub view video data of 3D video of the 3D multimedia service are composed, and second view video data constituting one of difference information, depth information, and parallax information between the main view video data and the sub view video data; and reproducing the first and second view video data by converting formats of the first and second view video data into 3D reproduction formats so as to be reproducible by a 3D display device, by using the 3D additional information.

The restoring may include generating intermediate view video data of the main and sub view video data by using the first and second view video data, and reproducing of the first and second view video data includes reproducing the first, intermediate, and second view video data by converting formats of the first, intermediate, and second view video data into 3D reproduction formats by using ay least one of the reference information and the 3D additional information.

The reproducing may include: restoring a plurality of pieces of 2D video data forming 3D video; and reproducing the plurality of pieces of 2D video data selectively or in a picture-in-picture (PIP) reproduction mode, by using at least one of the reference information and the 3D additional information.

The method may further include reproducing the extracted video data of each view in 3D by using at least one of the reference information and the 3D additional information by decoding and restoring the extracted video data of each view, wherein the reproducing may include cropping a region of the main view video data exceeding the sub view video data based on the cropping offset information in the aspect ratio descriptor information, and reproducing the extracted video data of each view in 3D by using the cropped main view video data and the sub view video data.

The method may further include reproducing the extracted video data of each view in 3D by using at least one of the reference information and the 3D additional information by decoding and restoring the extracted video data of each view, wherein the reproducing may include: generating extended sub view video data by filling a region of the sub view video data, which is smaller than the main view video data, with respective main view video data based on the cropping offset information in the aspect ratio descriptor information; and reproducing the extracted video data of each view in 3D by using the main view video data and the extended sub view video data.

According to an aspect of another exemplary embodiment, there is provided an apparatus for generating a data stream for providing a 3D multimedia service, the apparatus including: an ES generator which generates at least one ES including video data of each view from a program for providing at least one of a 2D multimedia service and a 3D multimedia service; a PMT generator which generates PMT information about the program, including reference information about the at least one ES and 3D additional information for identifying and reproducing the video data of each view according to views; a TS generator which generates at least one TS by multiplexing PES packets generated by packetizing the at least one ES, and the PMT information; and a channel transmitter which synchronizes and transmits the at least one TS with a channel.

According to an aspect of another exemplary embodiment, there is provided an apparatus for receiving a data stream for providing a 3D multimedia service, the apparatus including: a TS receiver which receives at least one TS about a program for providing at least one of a 2D multimedia service and a 3D multimedia service; a TS demultiplexer which extracts PES packets about the program and PMT information about the program by demultiplexing the at least one TS; a PMT 3D additional information extractor which extracts reference information about at least one ES including video data of each view from the program, and 3D additional information for identifying and reproducing the video data of each view, from the PMT information; an ES restorer which restores the at least one ES by using the extracted reference information about the at least one ES from among ESs extracted by depacketizing the PES packets, and extracts the video data of each view from the at least one ES; and a reproducer which decodes and restores the extracted video data of each view and reproduces the restored video data of each view in 3D by using at least one of the 3D additional information and the reference information.

According to an aspect of another exemplary embodiment, there is provided a computer readable recording medium having recorded thereon a program for executing the method of generating a data stream for providing 3D multimedia service.

According to an aspect of another exemplary embodiment, there is provided a computer readable recording medium having recorded thereon a program for executing the method of receiving a data stream for providing 3D multimedia service.

### BRIEF DESCRIPTION OF THE DRAWINGS

The above and/or other aspects will become more apparent by describing in detail exemplary embodiments with reference to the attached drawings in which:

FIG. 1 is a block diagram of an apparatus for generating a data stream for providing a three-dimensional (3D) multimedia service, according to an exemplary embodiment;

FIG. 2 is a block diagram of an apparatus for receiving a data stream for providing a 3D multimedia service, according to an exemplary embodiment;

FIG. 3 is a block diagram of an apparatus for transmitting a digital broadcast, based on a Moving Picture Experts Group (MPEG) transport stream (TS) system, according to an exemplary embodiment;

FIG. 4 is a block diagram of an apparatus for receiving a digital broadcast, based on an MPEG TS system, according to an exemplary embodiment;

FIG. 5 is a block diagram of an apparatus for transmitting an MPEG TS for transmitting a plurality of video elementary streams (ESs) according to an apparatus for generating a data stream, according to an exemplary embodiment;

FIG. 6 is a block diagram of an apparatus for receiving an MPEG TS for receiving a plurality of video ESs according to an apparatus for receiving a data stream, according to an exemplary embodiment;

FIG. 7 is a table for describing a 3D composite format according to an exemplary embodiment;

FIG. 8 is a table showing various combinations of ESs of video data in a plurality of views forming a 3D video, according to an exemplary embodiment;

FIG. 9A illustrates an example of 3D video descriptor information about a sub ES being included in 3D video descriptor information about a main ES from among 3D additional information of a program map table (PMT) information, according to an exemplary embodiment;

FIG. 9B illustrates a stream structure of the PMT information of FIG. 9A;

FIG. 10A illustrates an example of 3D video descriptor information about a main ES and 3D video descriptor information about a sub ES from among 3D additional information of PMT information being sequentially included, according to an exemplary embodiment;

FIG. 10B illustrates a stream structure of the PMT information of FIG. 10A;

FIG. 11 illustrates an example of using mode conversion information according to an exemplary embodiment;

FIG. 12 illustrates an example when a left view video and a right view video are transmitted in different sizes according to an exemplary embodiment;

FIG. 13 illustrates an example of using aspect ratio information according to an exemplary embodiment;

FIG. 14 is a block diagram of a system for communicating a 3D video data stream, according to an exemplary embodiment, in which an apparatus for transmitting a data stream and an apparatus for receiving a data stream are realized;

FIG. 15 is a flowchart illustrating a method of generating a data stream for providing a 3D multimedia service, according to an exemplary embodiment; and

FIG. 16 is a flowchart illustrating a method of receiving a data stream for providing a 3D multimedia service, according to an exemplary embodiment.

### DETAILED DESCRIPTION OF EXEMPLARY EMBODIMENTS

Hereinafter, exemplary embodiments will be described more fully with reference to the accompanying drawings. It is understood that expressions such as “at least one of,” when preceding a list of elements, modify the entire list of elements and do not modify the individual elements of the list. Further, a “unit” as used herein may be embodied as a hardware component and/or a software component that is executed by a computer or a hardware processor.

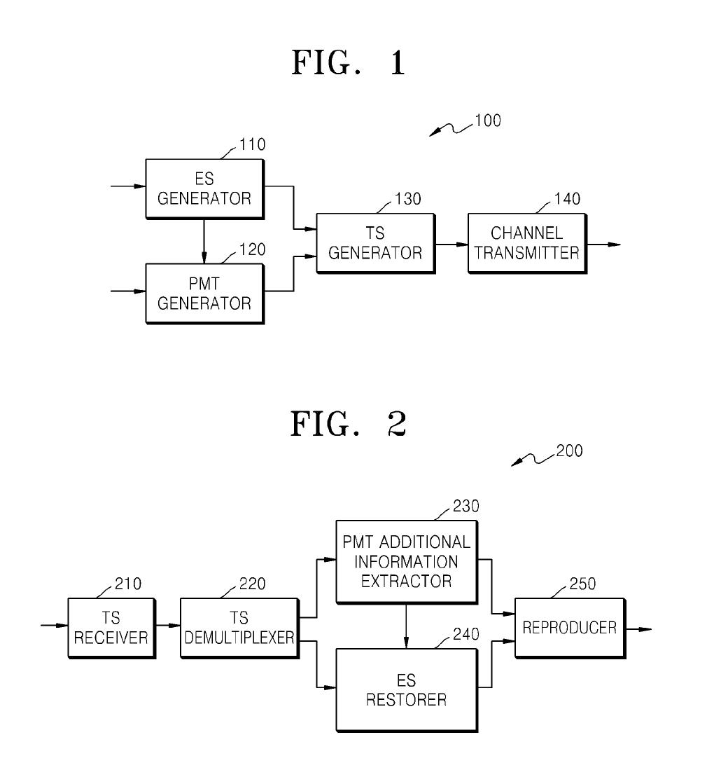

FIG. 1 is a block diagram of an apparatus 100 for generating a data stream for providing a three-dimensional (3D) multimedia service, according to an exemplary embodiment.

The apparatus 100 includes an elementary stream (ES) generator 110, a program map table (PMT) generator 120, a transport stream (TS) generator 130, and a channel transmitter 140.

The ES generator 110 receives video data of each view of at least one of 2D video and 3D video, and generates at least one ES including the video data of each view. The received video data of each view, and audio data and sub data related to the video data of each view form a program, and the ES generator 110 may generate an ES about the video data of each view and the audio data for forming a program for providing a 2D or 3D multimedia service.

The video data of each view for the 3D multimedia service may include main view video data and at least one piece of sub video data. The sub video data may be sub view video data itself, video data of a 3D composite format in which the main view video data and the sub view video data are composed, depth information between the main view video data and the sub view video data, parallax information, or difference information between the main view video data and the sub view video data.

The ES generator 110 may insert a plurality of pieces of video data of each view into each ES. The ESs for video data of one program may include a main ES and at least one sub ES. The main view video data or the video data of the 3D composite format may be inserted into the main ES. The sub video data may be inserted into the sub ES.

The PMT generator 120 generates PMT information about a program related to the ESs generated by the ES generator 110. The PMT information includes reference information about data, such as video data, audio data, and sub data for forming a program. The reference information may be at least one of packet identifier (PID) information of the TS including the data, and stream type information. When a plurality of ESs, into which the video data of each view for one program is inserted, are generated, the PMT information may include at least one of the PID information according to ESs and the stream type information.

The PMT generator 120 inserts at least one of reference information and 3D additional information, which results from characteristics that the 3D video of a respective program is formed of video of at least two views, into the PMT information. The 3D additional information may be used to identify and reproduce the video data of each view of the respective program according to views. When the plurality of ESs, into which the video data of each view for one program is inserted, are generated, at least one of the 3D additional information and the reference information may be set according to ESs.

The stream type information of an ES may be set for each ES. The PMT generator 120 may insert the stream type information of the main ES and the sub ES, into which respective video data is inserted, into the reference information. For example, when the apparatus 100 is based on an MPEG TS system, the stream type information of the main ES and the stream type information of the sub ES may be set by using stream type information set in the MPEG TS system.

The PMT generator 120 may insert at least one of the 3D additional information and the reference information into descriptor information about a respective ES from the PMT information. The PMT generator 120 may generate PMT information having a structure that varies according to a location of the 3D additional information or the reference information of the main ES and the sub ES in the PMT information.

In the PMT information according to a first exemplary embodiment, the 3D additional information of the main ES includes at least one of the 3D additional information and the reference information of the sub ES.

The PMT generator 120 may insert at least one of the 3D additional information and the reference information of the sub ES into 3D sub descriptor information about the main ES from the PMT information according to the first exemplary embodiment. In other words, the 3D additional information or the reference information of the main ES has a hierarchical relationship with the 3D additional information or the reference information of the sub ES.

The PMT information according to a second exemplary embodiment sequentially includes ES information about each ES. The PMT generator 120 may insert the 3D sub descriptor information into the ES information about the sub ES or the main ES from the PMT information according to the second exemplary embodiment. In other words, the 3D additional information or the reference information of the main ES has a parallel relationship with the 3D additional information or the reference information of the sub ES.

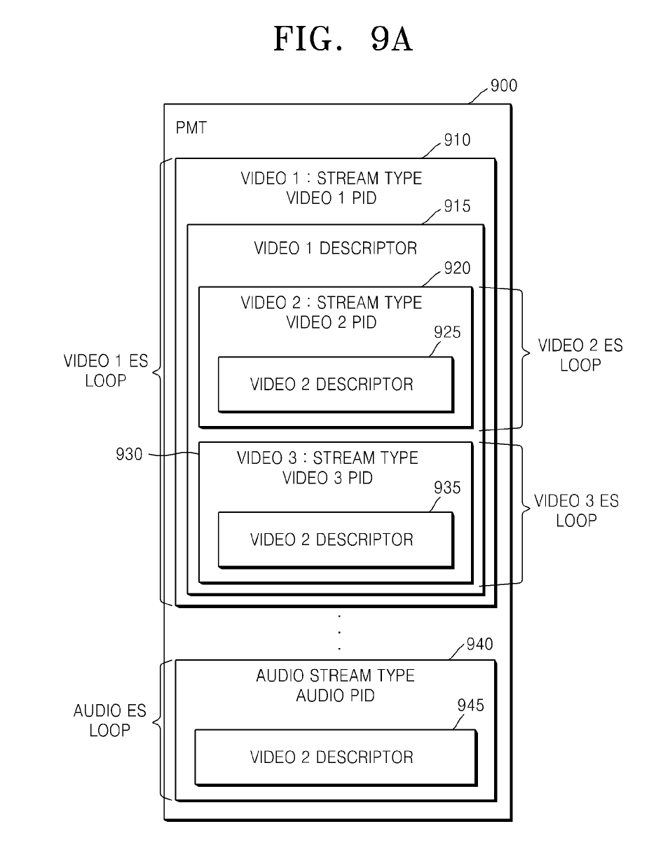

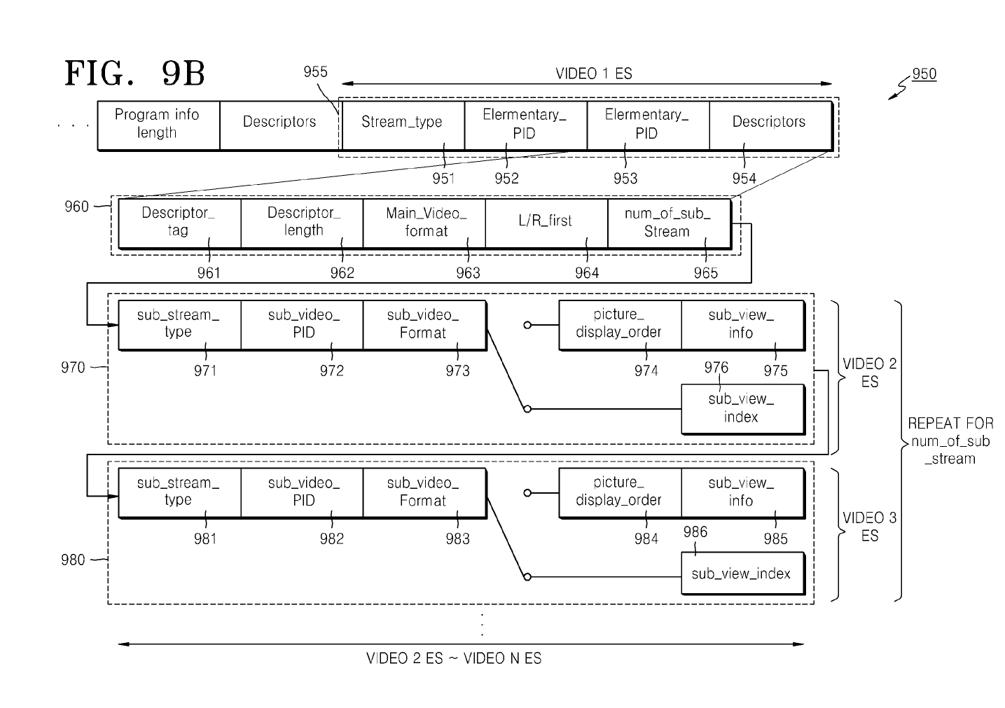

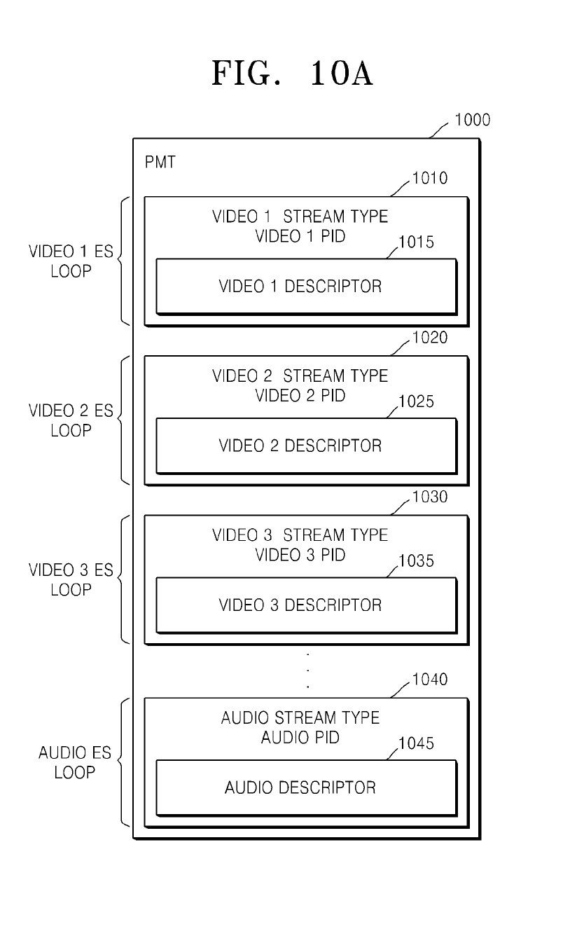

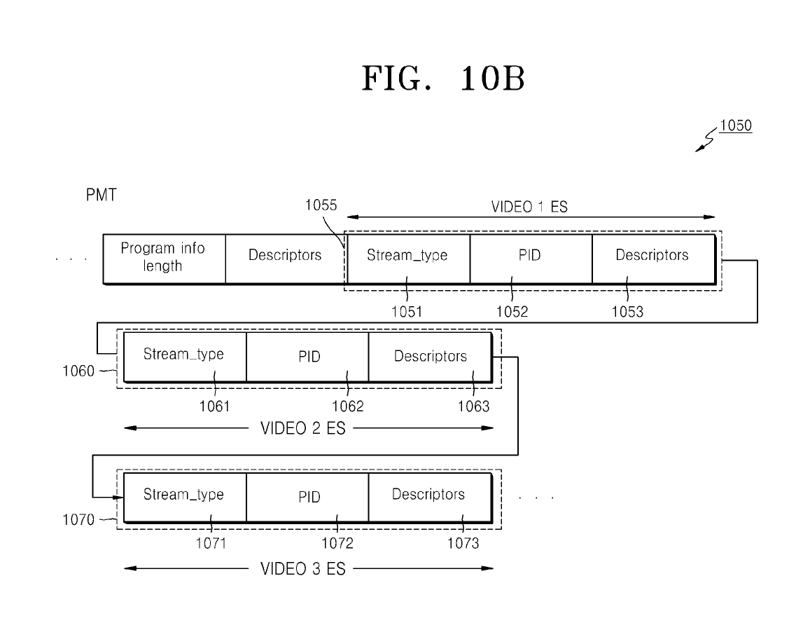

For example, the 3D additional information may include information about the video data of each view, such as view identification information of video data inserted into a respective ES, 3D composite format information, view priority information, and codec information. The PMT information according to the first exemplary embodiment, and the related reference information and 3D additional information will be described later with reference to FIGS. 9A and 9B, and Tables 5 and 6. The PMT information according to the second exemplary embodiment, and the related reference information and 3D additional information will be described later with reference to FIGS. 10A and 10B, and Tables 7 through 20.

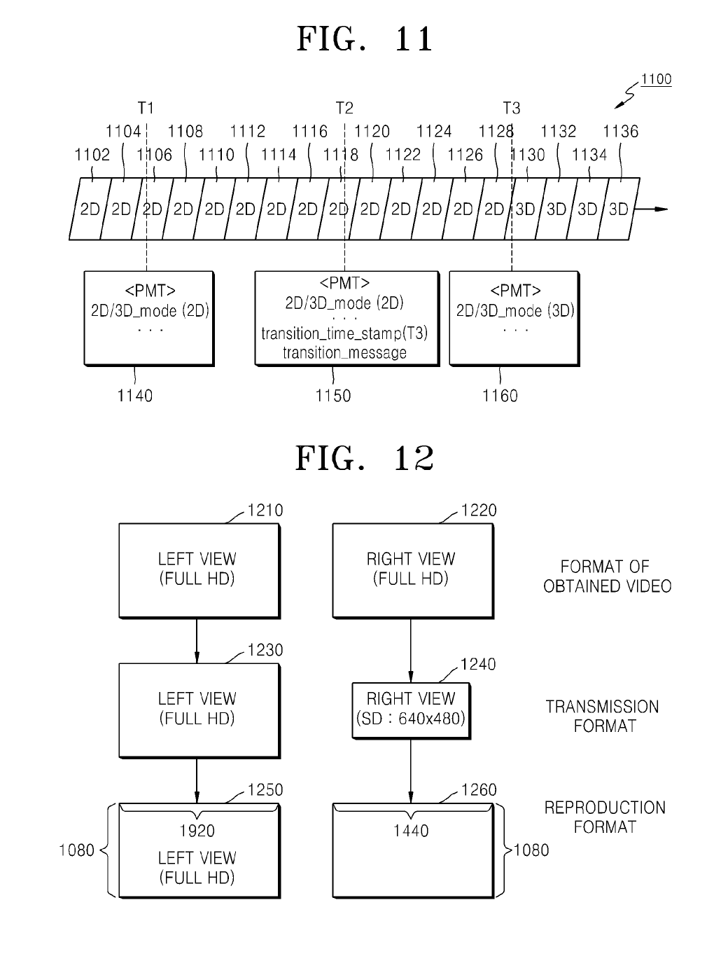

The PMT generator 120 may insert 2D/3D mode information indicating whether the video data is inserted into the TS, 2D/3D mode switch notice information, or 2D/3D notice descriptor information, into the PMT information. Details about the 3D additional information regarding the 2D/3D mode or 2D/2D mode switch will be described later with reference to Tables 3, 4, 21, and 22, and FIG. 11.

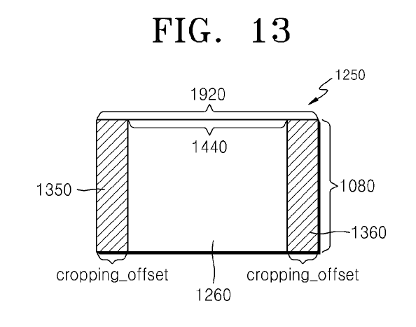

If sizes or aspect ratios of main view video data and sub view video data are different, the PMT generator 120 may insert aspect ratio descriptor information and cropping offset information about a method of adjusting regions for displaying the main view video data and the sub view video data during 3D reproduction, into the PMT information. Details about the 3D additional information about a cropping offset or an aspect ratio will be described later with reference to Table 23 and FIGS. 12 and 13.

The TS generator 130 generates packetized elementary stream (PES) packets by packetizing the at least one ES received from the ES generator 110. The TS generator 130 may generate TSs by multiplexing the PES packets and the PMT information received from the PMT generator 120.

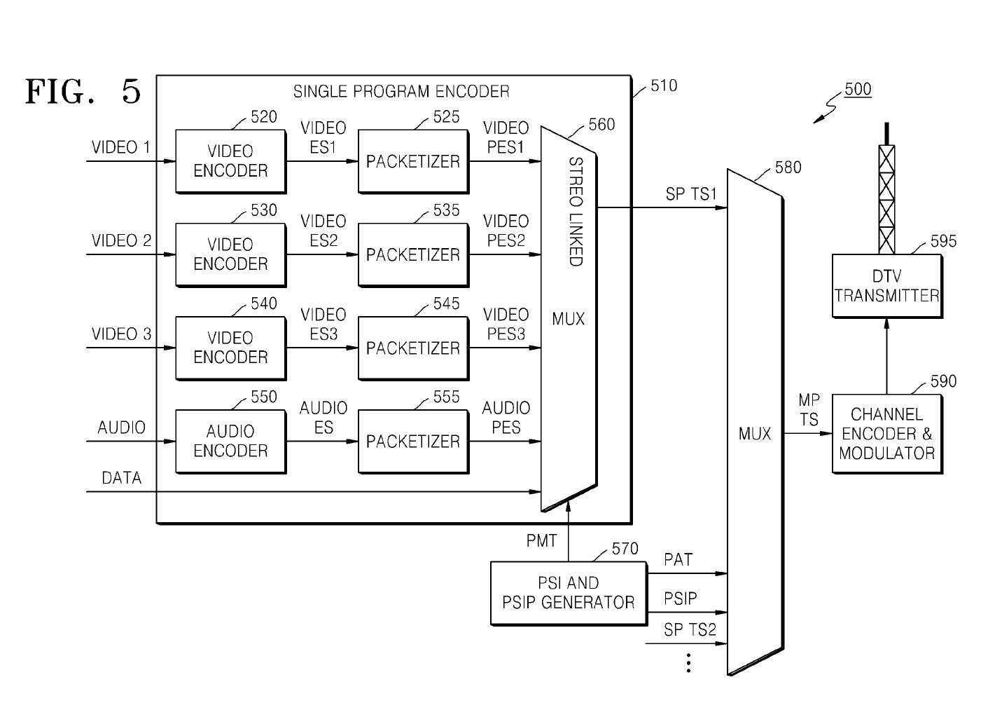

The channel transmitter 140 synchronizes the TSs received from the TS generator 130 with a channel, and transmits the synchronized TSs through the channel. Operations about the ES generator 110, the TS generator 130, and the channel transmitter 140 will be described later in detail while describing processes of generating a single program, PES packets, and TSs with reference to FIG. 5.

FIG. 2 is a block diagram of an apparatus 200 for receiving a data stream for providing a 3D multimedia service, according to an exemplary embodiment.

The apparatus 200 includes a TS receiver 210, a TS demultiplexer 220, a PMT additional information extractor 230, an ES restorer 240, and a reproducer 250.

The TS receiver 210 receives TSs about a program for providing a 2D or 3D multimedia service through a predetermined channel. The TS demultiplexer 220 demultiplexes the TSs received from the TS receiver 210, and extracts PES packets about the program and PMT information about the program. The PMT additional information extractor 230 extracts reference information about a TS or at least one ES including video data of each view in the program, from the PMT information extracted by the TS demultiplexer 220.

The ES restorer 240 restores ESs by depacketizing the PES packets extracted by the TS demultiplexer 220. Here, the ESs, to which the same type of data is inserted, may be respectively restored by using the reference information about the ES extracted from the PMT information. The ES restorer 240 extracts the video data of each view of the program from the ES. Similarly, the ES restorer 240 may extract audio data by restoring audio ES.

The PMT additional information extractor 230 extracts at least one of 3D additional information and reference information about the video data of each view of 2D or 3D video from the PMT information extracted by the TS demultiplexer 220.

If a plurality of ESs, into which the video data of each view of one program is inserted, exist, the PMT additional information extractor 230 may extract at least one of the 3D additional information and the reference information according to ESs.

The PMT additional information extractor 230 may extract stream type information about a respective ES from the reference information. For example, if the apparatus 200 is based on an MPEG TS system, stream type information about a main ES and stream type information about a sub ES may be set by using stream type information defined by the MPEG TS system.

The PMT additional information extractor 230 may extract at least one of the 3D additional information and the reference information from descriptor information about a respective ES, from the PMT information. The PMT additional information extractor 230 may extract at least one of the 3D additional information and the reference information about the main ES and the sub ES, from the PMT information having a structure that varies based on locations of the 3D additional information and the reference information in the PMT information. For example, PMT information according to a first exemplary embodiment, which includes the 3D additional information and the reference information about the sub ES in a lower layer of the 3D additional information about the main ES, and PMT information according to a second exemplary embodiment, which sequentially includes 3D additional information and reference information about each of the at least one ES, according to ESs, may exist.

The PMT additional information extractor 230 may extract at least one of the 3D additional information and reference information about the sub ES from 3D sub descriptor information about the main ES from the PMT information according to the first exemplary embodiment.

The PMT additional information extractor 230 may extract the 3D sub descriptor information from the ES information about the sub ES or main ES from the PMT information according to the second exemplary embodiment.

For example, The PMT additional information extractor 230 may extract information about the video data of each view, such as view identification information of video data inserted into a respective ES, 3D composite format information, view priority information, size information of the video data of each view, and codec information, from the 3D additional information. The PMT additional information extractor 230 may extract 2D/3D mode information indicating whether 2D video data or 3D video data is included in the TS, 2D/3D mode switch notice information, or 3D notice descriptor information from the PMT information.

The PMT additional information extractor 230 may extract aspect ratio descriptor information and cropping offset information about a method of adjusting regions for displaying the main view video data and the sub view video data during 3D reproduction, from the PMT information. If sizes or aspect ratios of main view video data and sub view video data are different, the aspect ratio descriptor information or the cropping offset information may be used to adjust sizes of the video data of each view to be the same during the 3D reproduction using the main view video data and the sub view video data.

The reproducer 250 decodes and restores the video data of each view extracted by the ES restorer 240, and reproduces the 3D video image restored by using at least one of the 3D additional information and the reference information extracted by the PMT additional information extractor 230, in 3D.

The reproducer 250 may convert a format of the video data of each view extracted from the main ES and the sub ES to a 3D reproduction format to be reproduced by the reproducer 250. For example, the reproducer 250 extracts the main view video data from the main ES, and the sub view video data from the sub ES. The reproducer 250 may convert formats of the extracted main view video data and sub view video data into 3D reproduction formats to reproduce the extracted main view video data and sub view video data.

Alternatively, the reproducer 250 may extract the main view video data from the main ES, and extract at least one or a combination of the sub view video data, depth information, parallax information, and difference information from the sub ES. Alternatively, the reproducer 250 may extract video data having a 3D composite format from the main ES, and extract at least one of the depth information, the parallax information, and the difference information from the sub ES. Here, the reproducer 250 may restore the main view video data and the sub view video data from the extracted video data, convert formats of the main view video data and the sub view video data into 3D reproduction formats, and reproduce the main view video data and the sub view video data.

Since the PMT information generated by the apparatus 100 may include the ES information according to a plurality of ESs including the 3D video data, and at least one of the 3D additional information and the reference information, the at least one of the 3D additional information and the reference information is transmitted and received along with a 3D video data stream. Accordingly, the 3D video may be accurately reproduced by a receiver. The receiver may be a set-top box, a display device, or a computer including a multimedia processor.

In a related art MPEG TS system, a TS about a 2D video is assumed, and thus only descriptor information about one video is set in one piece of PMT information.

The apparatus 100 inserts the 3D additional information and the reference information (or the 3D descriptor information) additionally into the video descriptor information in the PMT information of the related art MPEG TS system, and thus the receiver including the apparatus 200 may recognize and extract the 3D additional information and the reference information (or the 3D descriptor information) to be used to reproduce the 3D video. Also, since a receiving system complying with the related art MPEG TS system is unable to recognize the 3D additional information and the reference information (or the 3D descriptor information), the receiving system only reads and uses related art descriptor information.

Accordingly, the apparatus 100 transmits a data stream including the PMT information including the 3D additional information and the reference information (or the 3D descriptor information), and the receiving system that received the data stream maintains compatibility with the related art MPEG TS system since the receiving system is able to provide only a 2D multimedia service regardless of the 3D additional information and the reference information (or the 3D descriptor information), whereas the receiver including the apparatus 200 provides the 3D multimedia service.

Also, since the apparatuses 100 and 200 may set the stream type information of each ES by using the stream type information defined by the related art MPEG TS system, a new stream type may not be additionally assigned nor allocated additional bits compared to a data stream structure of the related art MPEG TS system.

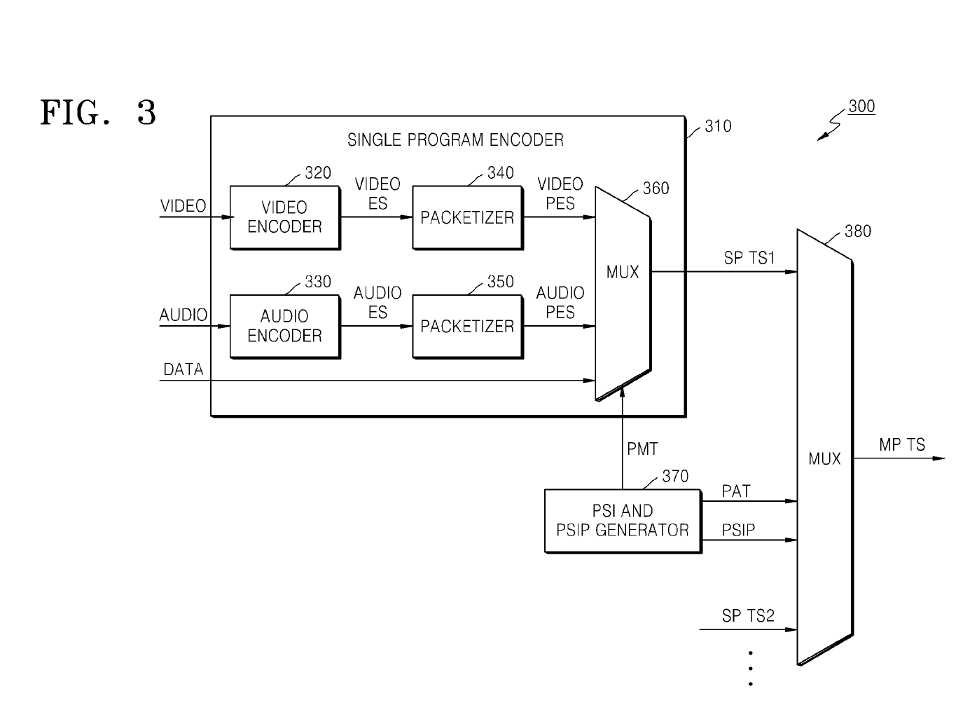

FIG. 3 is a block diagram of an apparatus 300 for transmitting a digital broadcast, based on an MPEG TS system, according to an exemplary embodiment.

In the apparatus 300, a single program encoder 310 generates a single program TS including a video TS and an audio TS, and a multiplexer (MUX) 380 generates and transmits a multi program TS (MP TS) by using at least one single program TS generated by a plurality of the single program encoders 310. Since the apparatus 300 is based on an MPEG TS system using a multi mode service (MMS) mode, the multi program TS generated by multiplexing the single program TS may be transmitted so as to transmit a plurality of programs.

The single program encoder 310 includes a video encoder 320, an audio encoder 330, packetizers 340 and 350, and a MUX 360.

The video encoder 320 and the audio encoder 330 respectively encode uncompressed video data and uncompressed audio data, thereby respectively generating and outputting a video ES and an audio ES. The packetizers 340 and 350 of the single program encoder 310 respectively packetize the video ES and the audio ES, and respectively generate a video PES packet and an audio PES packet by inserting a PES header.

The MUX 360 multiplexes the video PES packet, the audio PES packet, and various sub data to form a first single program TS (SP TS1). The PMT information may be multiplexed with the video PES packet and the audio PES packet to be included in the first single program TS. The PMT information is included in each single program TS to describe PID information of each TS.

The MUX 380 may multiplex a plurality of single program TSs (SP TS1, SP TS2, and so on) with program association table (PAT) information so as to form one multi program TS (MP TS).

The PMT information and the PAT information are generated by a program specification information (PSI) and program and system information protocol (PSIP) generator 370.

The PAT information and a PSIP may be inserted into the multi program TS. The PAT information describes PID information of the PMT information about the single program TSs included in a respective multi program TS.

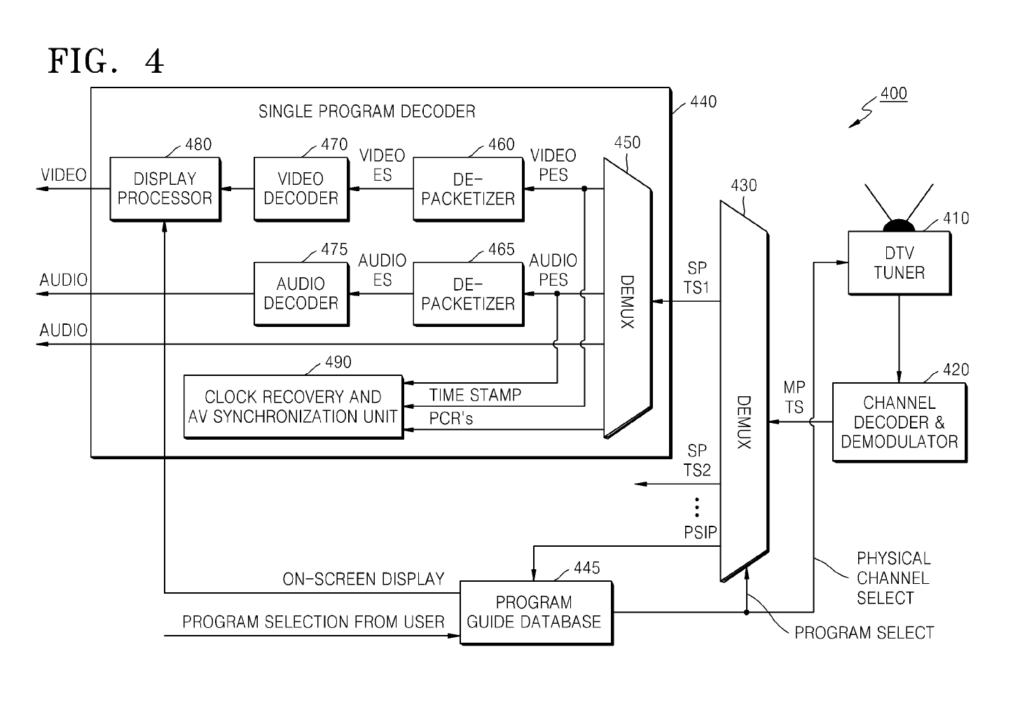

FIG. 4 is a block diagram of an apparatus 400 for receiving a digital broadcast, based on an MPEG TS system, according to an exemplary embodiment.

The apparatus 400 receives a digital data stream and extracts video data, audio data, and sub data from the digital data stream.

A digital TV (DTV) tuner 410 tunes to a radio frequency of a channel selected, based on a channel select signal (PHYSICAL CHANNEL SELECT), by a viewer, and selectively extracts a signal received through a corresponding radio wave.

A channel decoder and demodulator 420 extracts a multi program TS (MP TS) from a channel signal. Since the apparatus 400 is based on an MPEG TS system using an MMS method, the apparatus 400 may receive a multi program TS and demultiplex the multi program TS into single program TSs. The demultiplexer (DEMUX) 430 separates the multi program TS into a plurality of single TSs (SP TS1, SP TS2, and so on) and a PSIP.

A first single program TS (SP TS1) selected by a program select signal (PROGRAM SELECT) by the viewer is decoded by a single program decoder 440. The single program decoder 440 operates in an inverse order of the single program encoder 310. A video PES packet, an audio PES packet, and sub data are restored from the first single program TS. The video PES packet and the audio PES packet are restored to ES forms respectively through depacketizers 460 and 465, and the video ES and the audio ES are restored to video data and audio data respectively through a video decoder 470 and an audio decoder 475. The video data may be converted into a displayable format by using a display processor 480.

A clock recovery and audio-video (AV) synchronization unit 490 may synchronize reproduction times of the video data and the audio data by using program clock reference (PCR) information and time stamp information extracted from the first single program TS.

The PSIP extracted from the multi program TS (MP TS) and a program guide database 445 are compared based on a program selection signal input by a user, thereby searching for a channel and a program corresponding to the program selection signal from the program guide database 445. The found channel and the program may be respectively output to the DTV tuner 410 and the DEMUX 430. Also, an on-screen display operation may be supported as on-screen display information is transmitted from the program guide database 445 to the display processor 480.

The apparatus 100 described with reference to FIG. 1 generates a TS about one program including the video data of each view, the audio data, and the sub data of the 3D video, i.e., a single program TS, but an operation of the apparatus 100 is not limited to one video. In other words, the apparatus 100 may generate a single program TS including a plurality of videos, if a plurality of pieces of video data, audio data, and sub data are input.

FIG. 5 is a block diagram of an apparatus 500 for transmitting an MPEG TS for transmitting a plurality of video ESs according to the apparatus 100, according to an exemplary embodiment.

The apparatus 500 is provided by expanding the apparatus 100 so as to support an MPEG TS including a plurality of videos in one program. In other words, operations of a single program encoder 510 and a MUX 580 of the apparatus 500 correspond to operations of the ES generator 110 and the TS generator 130 of the apparatus 100, operations of a PSI and PSIP generator 570 of the apparatus 500 correspond to operations of the PMT generator 120 of the apparatus 100, and operations of a channel encoder and modulator 590 and a DTV transmitter 595 of the apparatus 500 correspond to operations of the channel transmitter 140 of the apparatus 100.

The single program encoder 510 receives a first video (VIDEO 1), a second video (VIDEO 2), and a third video (VIDEO 3) of the 3D video, and generates a first video ES (VIDEO ES 1), a second video ES (VIDEO ES 2), and a third video ES (VIDEO ES 3) respectively through video encoders 520, 530, and 540. The first, second and third videos may respectively be a first view video, a second view video, and a third view video of the 3D video, or may be a combination of at least one of the first, second, and third view videos.

The video encoders 520 and 530 may independently comply with a video encoding method. For example, the first and second videos are encoded according to an MPEG-2 video encoding method, and the third video may be encoded according to an MPEG Advanced Video Coding (AVC)/H.264 video encoding method.

The first, second and third video ESs are packetized into a first video PES packet (VIDEO PES 1), a second video PES packet (VIDEO PES 2), and a third video PES packet (VIDEO PES 3) through packetizers 525, 535, and 545, respectively.

The single program encoder 510 may receive audio and convert the audio into an audio ES (AUDIO ES) through an audio encoder 550, and the audio ES may be converted into an audio PES packet (AUDIO PES) through a packetizer 555.

An MUX 560 of the single program encoder 510 may output a first single program TS (SP TS 1) by multiplexing the first through third video PES packets and the audio PES packet together. The MUX 560 may insert various types of sub data received by the single program encoder 510 and PMT information generated by a PSI and PSIP generator 570 into the first single program TS, along with the first through third video PES packets and the audio PES packet.

Another piece of 3D video data may be multiplexed to a second single program TS (SP TS 2). The PSI and PSIP generator 570 may generate PAT information, which includes PID information of PMT information included in the first and second single program TSs, and a PSIP about various programs and system information. The MUX 580 may output one multi program TS (MP TS) by multiplexing the first and second single program TSs and the PAT information.

The channel encoder and modulator 590 may encode and synchronize the multi program TS according to a channel. The DTV transmitter 595 may transmit the TS assigned to a channel.

The single program encoder 510 may generate each TS according to an independent digital data communication method. The TSs may be generated and transmitted according to the same or different digital data communication methods according to programs. For example, an Advanced Television Systems Committee (ATSC) terrestrial broadcasting communication method supports an Enhanced Vestigial Sideband (E-VSB) method, wherein the E-VSB method may form a TS using a different method from an MPEG method. However, the E-VSB generates PMT information about a program and inserts the PMT information into a TS as performed in the MPEG method. Accordingly, the first single program TS may be transmitted as a MPEG TS, the second single program TS may be transmitted as an E-VSB TS, and PMT information including 3D additional information about video data of each view forming each program may be inserted into the first and second single program TSs.

The apparatus 200 described with reference to FIG. 2 receives a TS about one program, i.e., a single program TS, but operations of the apparatus 200 are not limited to one program. In other words, the apparatus may receive a TS according to programs about a plurality of programs, extract PMT information according to programs from a plurality of TSs, and extract video data, audio data, and sub data of the plurality of programs.

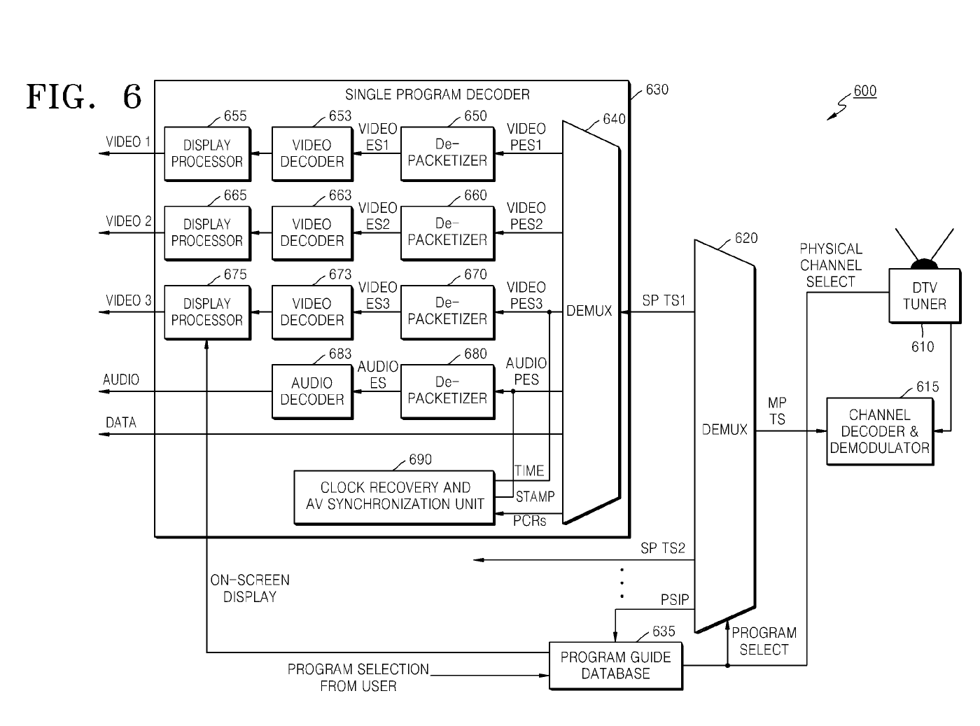

The apparatus 200 supporting an MPEG TS, wherein a program includes a plurality of videos, will now be described with reference to FIG. 6.

FIG. 6 is a block diagram of an apparatus 600 for receiving an MPEG TS for receiving a plurality of video ESs according to the apparatus 200, according to an exemplary embodiment.

The apparatus 600 is provided by expanding the apparatus 200 so as to support the MPEG TS, in which one program includes a plurality of videos. In other words, operations of a channel decoder and demodulator 615, a DEMUX 620, and a single program decoder 630 of the apparatus 600 respectively correspond to operations of the TS receiver 210, the TS demultiplexer 220, the PMT additional information extractor 230, and the ES restorer 240 of the apparatus 100.

A DTV tuner 610 selectively extracts a signal received through a radio wave of a channel selected by a viewer. The channel decoder and demodulator 615 extracts a multi program TS from a channel signal. The multi program TS is separated into a plurality of single program TSs (SP TS 1, SP TS2, and so on), and a PSIP through the DEMUX 620.

The single program decoder 630 decodes the first single program TS (SP TS1) selected by the viewer. The first single program TS is demultiplexed to restore a first video PES packet (VIDEO PES 1), a second video PES packet (VIDEO PES 2), a third video PES packet (VIDEO PES 3), an audio PES packet (AUDIO PES), and sub data (DATA). The first through third video PES packets are restored to a first video ES (VIDEO ES 1), a second video ES (VIDEO ES2), and a third video ES (VIDEO ES 3) through depacketizers 650, 660, and 670, respectively, and the first through third video ESs are restored to a first video, a second video, and a third video through video decoders 653, 663, and 673, respectively. The first through third videos may be converted into displayable formats through display processors 655, 665, and 675, respectively.

The audio PES packet is restored to audio data through a depacketizer 680 and an audio decoder 683.

A clock recovery and AV synchronization unit 690 may synchronize a reproduction time of the video data and the audio data by using PCR information and time stamp information extracted from the first single program TS.

Signals about a channel and a program corresponding to a program selection signal of a user may be transmitted from a program guide database 635 to the DTV tuner 610 and the DEMUX 620, based on the program selection signal input by the user. Also, on-screen display information may be transmitted from the program guide database 635 to the display processors 655, 665, and 675.

Accordingly, the apparatus 600 may extract one multi program TS about the first through third videos and the audio of the 3D video received through one channel, demultiplex the multi program TS, and selectively extract a desired single program TS. Also, the apparatus 600 may selectively extract a video ES about the first through third videos of the 3D video from the extracted single program TS to restore desired video data.

Here, the apparatus 600 may extract PMT information from the first single program TS, and extract 3D additional information or 3D descriptor information about the 3D video of a program from the PMT information. The 3D video may be accurately reproduced by accurately identifying video data of each view forming the 3D video by using the 3D additional information or the 3D descriptor information.

The 3D video data inserted into a payload of the TS generated by the apparatus 100 and received by the apparatus 200 includes the video data of each view of the 3D video. For convenience of description, a stereo image including a left view video and a right view video is used as the 3D video. However, the 3D video is not limited to the stereo image, and may be a video having at least three views.

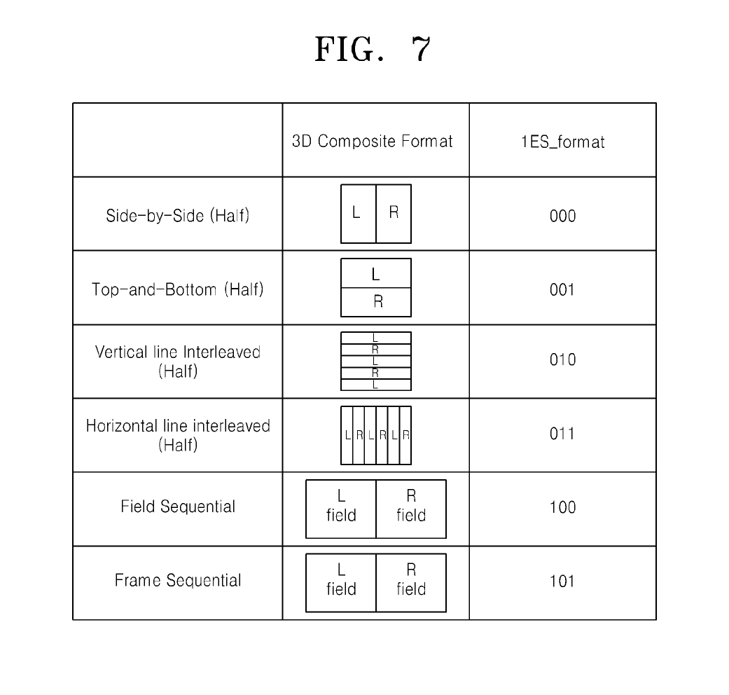

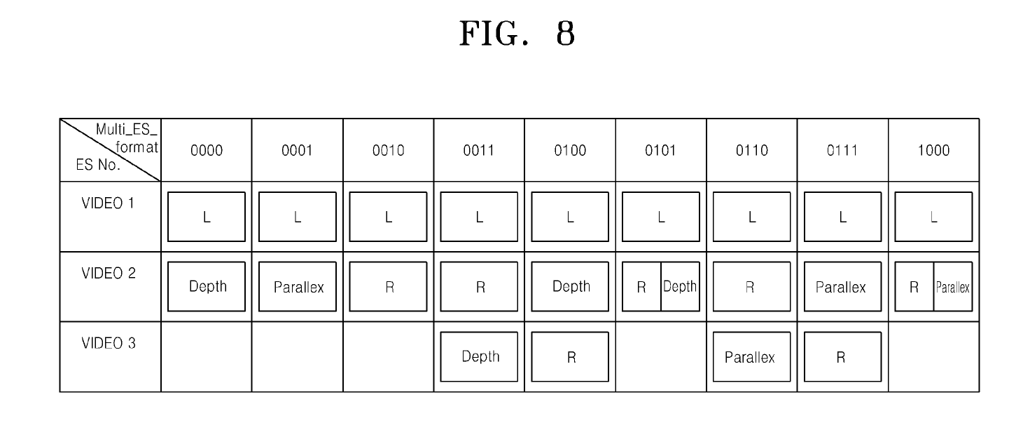

The 3D video data may have a 3D composite format, wherein left view image data and right view image data of the 3D video are both inserted into one image, or a 3D hybrid format, wherein a combination of at least three of left view image data, right view image data, depth information, parallax information, and difference information is inserted into at least two images. The 3D composite format and the 3D hybrid format will now be described in detail with reference to FIGS. 7 and 8.

FIG. 7 is a table for describing a 3D composite format according to an exemplary embodiment.

Examples of the 3D composite format include a side-by-side format, a top-and-bottom format, a vertical line interleaved format, a horizontal line interleaved format, a field sequential format, and a frame sequential format.

The side-by-side format is an image format in which a left view image and a right view image, which correspond to each other, are arranged on a left region and a right region of an image of the 3D composite format, respectively. The top-and-bottom format is an image format in which a left view image and a right view image, which correspond to each other, are arranged on an upper region and a lower region of an image of the 3D composite format, respectively.

The vertical line interleaved format is an image format in which a left view image and a right view image, which correspond to each other, are arranged on an odd numbered vertical line and an even numbered vertical line of an image of the 3D composite format, respectively. The horizontal line interleaved format is an image format in which a left view image and a right view image, which correspond to each other, are arranged on an odd numbered horizontal line and an even numbered horizontal line of an image of the 3D composite format, respectively.

The field and frame sequential formats are image formats in which a left view image and a right view image, which correspond to each other, are arranged on odd numbered frames and information, and even numbered frames and information of the image of the 3D composite format, respectively.

A 3D image having the side-by-side format, the top-and-bottom format, the vertical line interleaved format, or the horizontal line interleaved format has the left view image and the right view image, which have a resolution that is half that of an original image.

When the 3D video data is inserted into one ES without a sub ES, in the 3D composite format, 3D additional information may include 3D composite format information (1ES_format) indicating a type of an image format of current 3D video data. In other words, a value of the 3D composite format information may be assigned to 3 bits as shown in FIG. 7, based on whether the 3D composite format of the 3D video data inserted into a current ES is a side-by-side format, a top-and-bottom format, a vertical line interleaved format, a horizontal line interleaved format, a field sequential format, or a frame sequential format.

FIG. 8 is a table showing various combinations of ESs of video data in a plurality of views forming a 3D video, according to an exemplary embodiment.

When 3D video data is inserted into at least two ESs, video data having a 3D hybrid format, into which left view image data, right view image data, depth information, parallax information, or difference information is inserted into each ES, may be inserted.

A type of the 3D hybrid format may be a format wherein left view video data is inserted into a first ES and sub video data is inserted into a second ES, when there are two ESs. In a first hybrid format, a second hybrid format, and a third hybrid format, the sub video data inserted into the second ES may be the depth information, the parallax information, or the right view video data.

Alternatively, the type of the 3D hybrid format may be a format wherein left view video data is inserted into a first ES and right view video data and any one of depth information and parallax information are inserted into a second ES or a third ES, when there are at least two ESs. In a fourth hybrid format, the right view video data is inserted into the second ES, and the depth information is inserted into the third ES. In a fifth hybrid format, the depth information is inserted into the second ES, and the right view video data is inserted into the third ES. In a sixth hybrid format, sub video data, in which the right view video data and the depth information are composed into one image, is inserted into the second ES. In a seventh hybrid format, the right view video data is inserted into the second ES, and the parallax information is inserted into the third ES. In an eighth hybrid format, the parallax information is inserted into the second ES, and the right view video data is inserted into the third ES. In a ninth hybrid format, sub video data, in which the right view video data and the parallax information are composed into one image, is inserted into the second ES.

The 3D hybrid format illustrated in FIG. 8 is only an example, and combinations and orders of the 3D hybrid format are not limited to FIG. 8.

When the 3D video data is inserted into at least two ESs, 3D additional information may include 3D hybrid format information (Multi_ES_format) indicating a type of an image format of current 3D video data. In other words, a value of the 3D hybrid format information may be assigned to 4 bits as shown in FIG. 8, based on the 3D hybrid format of the 3D video data inserted into the current ES, i.e., indicating which one of the first through ninth hybrid formats is the 3D hybrid format.

Table 1 below shows a syntax of the PMT information of the MPEG TS system. The apparatuses 100 and 200 use the TS and the PMT information, but a structure of the TS may be used in a digital communication method other than the MPEG TS system. Accordingly, the PMT information inserted into the TS and used by the apparatuses 100 and 200 is not limited to Table 1.

TABLE 1
Syntax

```
TS_program_map_section {
  table_id
  section_syntax_indicator
  ‘0’
  reserved
  section_length
  program_number
  reserved
  version_number
  current_next_indicator
  section_number
  last_section_number
  reserved
  PCR_PID
  reserved
  program_info_length
  for (i=0; i<N; i++) {
    descriptor( )
  }
  for (i=0; i<N1; i++) {
    stream_type
    reserved
    elementary_PID
    reserved
    ES_info_length
    for (j=0; j<N2; j++) {
      descriptor( )
    }
  }
  CRC_32
}
```

2D/3D mode information (‘2d/3d_mode’) of Table 3 and 2D/3D mode switch notice information (‘notice_indicator’) of Table 4 may be inserted into reserved information (‘reserved’) of the syntax of the PMT information.

A first for loop of the syntax of the PMT information is a program loop including information about various characteristics of a program described by current PMT information. 3D mode descriptor information (‘3D_mode_descriptor( )’) of Table 21 may be inserted into a descriptor region (‘descriptor( )’) of the program loop.

A second for loop of the syntax of the PMT information is an ES loop including information about various characteristics of ESs described by the current PMT information. 3D stream descriptor information (‘3d_stream_desctriptor( )’) of Table 5, 3D mode descriptor information (‘3D_mode_descriptor( )’) of Table 21, and 2D/3D mode switch notice descriptor information (‘3D_notice_descriptor( )’) of Table 22 may be inserted into a descriptor region (‘descriptor( )’) of the ES loop.

Stream type information (‘stream_type’) indicates a stream type of a corresponding ES. Table 2 below indicates stream types defined by the ISO/IEC 13818-1 standard of the MPEG TS system, and values assigned to each stream type.

TABLE 2

| Value | Description |
|---|---|
| 0x00 | ITU-T \| ISO/IEC Reserved |
| 0x01 | ISO/IEC 11172-2 Video |
| 0x02 | ITU-T Rec. H.262 \| ISO/IEC 13818-2 Video or ISO/IEC |
| | 11172-2 constrained parameter video stream |
| 0x03 | ISO/IEC 11172-3 Audio |
| 0x04 | ISO IEC 138 18-3 Audio |
| 0x05 | ITU-T Rec. H.222.0 \| ISO/IEC 13818-1 private_sections |
| 0x06 | ITU-T Rec. H.222.0 \| ISO/IEC 13818-1 PES packets |
| | containing private data |
| 0x07 | ISO/IEC 13522 MHEG |
| 0x08 | ITU-T Rec. H.222.0 \| ISO/IEC 13818-1 Annex A DSM-CC |
| 0x09 | ITU-T Rec. H.222.1 |
| 0x0A | ISO/IEC 13818-6 type A |
| 0x0B | ISO/IEC 13818-6 type B |
| 0x0C | ISO/IEC 13818-6 type C |
| 0x0D | ISO/IEC 13818-6 type D |
| 0x0E | ITU-T Rec. H.222.0 \| ISO/IEC 13818-1 auxiliary |
| 0x0F | ISO/IEC 13818-7 Audio with ADTS transport syntax |
| 0x10 | ISO/IEC 14496-2 Visual |
| 0x11 | ISO/IEC 14496-3 Audio with the LATM transport syntax as |
| | defined in ISO/IEC 14496-3 |
| 0x12 | ISO/IEC 14496-1 SL-packetized stream or FlexMux stream |
| | carried in PES packets |
| 0x13 | ISO/IEC 14496-s SL-packetized stream or FlexMux stream |
| | carried in ISO/IEC 14496_sections |
| 0x14 | ISO/IEC 13818-6 Synchronized Download Protocol |
| 0x15 | Metadata carried in PES packets |
| 0x16 | Metadata carried in metadata_sections |
| 0x17 | Metadata carried in ISO/IEC 13818-6 Data Carousel |
| 0x18 | Metadata carried in ISO/IEC 13818-6 Object Carousel |
| 0x19 | Metadata carried in ISO/IEC 13818-6 Synchronized |
| | Download Protocol |
| 0x1A | IPMP stream (defined in ISO/IEC 13818-11, MPEG-2 |
| | IPMP) |
| 0x1B | AVC video stream as defined in ITU-T Rec. H.264 \| |
| | ISO/IEC 14496-10 Video |
| 0x1C | ISO TEC 14496-3 Audio. without using any additional |
| | transport syntax, such as DST, ALS and SLS |
| 0x1D | ISO/IEC 1446-17 Text |
| 0x1E | Auxiliary video stream as defined in ISO/IEC 23002-3 |
| 0x1F~Ox7E | ITU-T Rec. H.222.0 \| ISO/IEC 13818-1 Reserved |
| 0x7F | IPMP stream |
| 0x80~0xFF | User Private |

The stream type information in each ES loop may be set to be any stream type of Table 2 according to a type of a corresponding ES. The stream types of Table 2 are examples of the stream types of the ES selectable by the apparatuses 100 and 200, and the selectable stream types are not limited to Table 2.

The structures of the PMT information according to the first and second exemplary embodiments, which are classified according to locations of 3D additional information in PMT information, will now be described in detail with reference to FIGS. 9A, 9B, 10A, and 10B, in comparison with the syntax of the PMT information of Table 1.

FIG. 9A illustrates an example of 3D video descriptor information about a sub ES being included in 3D video descriptor information about a main ES from among 3D additional information of PMT information 900, according to an exemplary embodiment.

The PMT information 900 according to the first exemplary embodiment includes a first ES loop (VIDEO 1 ES LOOP) 910 about a first video ES. The first ES loop 910 may include stream type information (VIDEO 1 STREAM TYPE), PID information (VIDEO 1 PID), and first video descriptor information (VIDEO 1 DESCRIPTOR) 915 about the first video ES. The first video descriptor information 915 may include a second ES loop (VIDEO 2 ES LOOP) 920 about a second video ES, and a third ES loop (VIDEO 3 ES LOOP) 930 about a third video ES.

The second ES loop 920 and the third ES loop 930 may respectively include second video descriptor information (VIDEO 2 DESCRIPTOR) 925 including 2D additional information about the second video ES, and third video descriptor information (VIDEO 3 DESCRIPTOR) 935 including 3D additional information about the third video ES.

The PMT information 900 according to the first exemplary embodiment may also include audio ES loop (AUDIO ES LOOP) 940 about an audio ES. The audio ES loop 940 may include stream type information (AUDIO STREAM TYPE), PID information (AUDIO PID), and audio descriptor information (AUDIO DESCRIPTOR) 945 about the audio ES.

In other words, the second for loop of the PMT information of Table 1 corresponds to the first ES loop 910. The first video descriptor information 915 is inserted into a descriptor region of the second for loop, and at the same time, the second ES loop 920 and the third ES loop 930 are inserted into a lower layer of the first video descriptor information 915. Accordingly, the second video descriptor information 925 and the third video descriptor information 935 may be inserted into the descriptor region of the second for loop. In other words, a hierarchical structure may be formed between the first video descriptor information 915, and the second and third video descriptor information 925 and 935.

FIG. 9B illustrates a stream structure of the PMT information 900 of FIG. 9A.

A PMT stream 950 of the PMT information according to the first exemplary embodiment includes a first video ES (VIDEO 1 ES) loop 955. The first video ES loop 955 includes a ‘stream_type’ field 951, an ‘Elementary_PID’ field 952, an ‘ES_info_length’ field 953, and a ‘Descriptors’ field 954. Corresponding information is inserted into each field.

First ES descriptor information 960 is inserted into the ‘Descriptors’ field 954 of the first video ES loop 955. The first ES descriptor information 960 includes a ‘Descriptor_tag’ field 961, a ‘Descriptor_length’ field 962, a ‘Main_Video_format’ field 963, an ‘L/R_first’ field 964, and a ‘num_of_sub_stream’ field 965. Information about an image format of a first video may be inserted into the ‘Main_Video_format’ field 963, view arrangement order information of a left view image and a right view image in a 3D composite format may be inserted into the ‘L/R_first’ field 964, and information about a number of sub ESs may be inserted into the ‘num_of_sub_stream’ field 965.

In the ‘Descriptors’ field 954 of the first video ES loop 955, a second video ES (VIDEO 2 ES) loop 970 and a third video ES (VIDEO 3 ES) 980 may be included as lower layers of the first ES descriptor information 960 after the first ES descriptor information 960. A plurality of sub ES loops corresponding to a value of the ‘num_of_sub_stream’ field 965 may be included in the ‘Descriptors’ field 954 of the first video ES loop 955, after the first ES descriptor information 960.

The second video ES loop 970 and the third video ES loop 980 may respectively include ‘sub_stream_type’ fields 971 and 981, ‘sub_video_PID’ fields 972 and 982, ‘sub_video_Format’ fields 973 and 983, ‘picture_display_order’ fields 974 and 984, ‘sub_view_info’ fields 975 and 985, and ‘sub_view_index’ fields 976 and 986.

Stream type information of second and third video ESs may be respectively inserted into the ‘sub_stream_type’ fields 971 and 981, PID information of the second and third video ESs may be inserted into the ‘sub_video_PID’ fields 972 and 982, and image format information of second and third video data may be inserted into the ‘sub_video_Format’ fields 973 and 983. Information about a reproduction order according to views of video data of each view forming a 3D video that includes first, second, and third videos may be inserted into the ‘picture_display_order’ fields 974 and 984. Information for adjusting a 3D effect for a child or an adult may be inserted into the ‘sub_view_info’ fields 975 and 985, and index information of the second and third video from among sub videos may be inserted into the ‘sub_view_index’ fields 976 and 986.

FIG. 10A illustrates an example of 3D video descriptor information about a main ES and 3D video descriptor information about a sub ES from among 3D additional information of PMT information 1000 being sequentially included, according to an exemplary embodiment.

A first ES loop (VIDEO 1 ES LOOP) 1010 about a first video ES, a second ES loop (VIDEO 2 ES LOOP) 1020 about a second video ES, a third ES loop (VIDEO 3 ES LOOP) 1030 about a third video ES, and an audio ES loop 1040 about an audio ES may be sequentially inserted into the PMT information 1000 according to the second exemplary embodiment.

The first ES loop 1010 may include stream type information (VIDEO 1 STREAM TYPE), PID information (VIDEO 1 PID), and first video descriptor information (VIDEO 1 DESCRIPTOR) 1015 about the first video ES.

Similarly, the second ES loop 1020 may include stream type information (VIDEO 2 STREAM TYPE), PID information (VIDEO 2 PID), and second video descriptor information (VIDEO 2 DESCRIPTOR) 1025 about the second video ES, and the third ES loop 1030 may include stream type information (VIDEO 3 STREAM TYPE), PID information (VIDEO 3 PID), and third video descriptor information (VIDEO 3 DESCRIPTOR) 1035 about the third video ES.

Here, the stream type information of the second video ES and the third video ES constituting sub ESs may be ‘Auxiliary video stream’ from among stream types. For example, ‘Auxiliary video stream as defined in ISO/IEC 23002-3’ in Table 2 may be selected as the stream type information of the second and third video ESs.

The audio ES loop 1040 may include stream type information (AUDIO STREAM TYPE), PID information (AUDIO PID), and audio descriptor information (AUDIO DESCRIPTOR) 1040 about the audio ES.

In other words, the first, second, and third ES loops 1010, 1020, and 1030 may be inserted into the second for loop of the PMT information of Table 1, and respective 3D additional information may be inserted into the first, second, and third video descriptor information 1015, 1025, and 1035 of the first, second, and third ES loops 1010, 1020, and 1030. That is, the first, second, and third ES loops 1010, 1020, and 1030 may have a parallel structure.

FIG. 10B illustrates a stream structure of the PMT information 1000 of FIG. 10A.

A PMT stream 1050 of PMT information according to the second exemplary embodiment includes a first video ES (VIDEO 1 ES) 1055, and may consecutively include a second video ES (VIDEO 2 ES) loop 1060 and a third video ES (VIDEO 3 ES) loop 1070 after the first video ES loop 1055. When a plurality of sub ES loops related to the first video ES exist so as to form a 3D video, each of the sub ES loops may be inserted after the first video ES loop 1055 in the PMT stream 1050.

The first video ES loop 1055, the second video ES loop 1060, and the third video ES loop 1070 may respectively include ‘Stream_type’ fields 1051, 1061, and 1070, ‘PID’ fields 1052, 1062, and 1072, and ‘Descriptors’ fields 1053, 1063, and 1073.

Stream type information of a respective video ES may be inserted into the ‘Stream_type’ fields 1051, 1061, and 1071, and PID information of the respective video ES may be inserted into the ‘PID’ fields 1052, 1062, and 1072. Information about video characteristics of video data of the respective video ES may be inserted into the ‘Descriptors’ fields 1053, 1063, and 1073, and the ‘Descriptors’ fields 1053, 1063, and 1073 may include 3D additional information or 3D descriptor information about characteristics of the respective video ES to form a 3D video.

The PMT information according to the first exemplary embodiment has been described with reference to FIGS. 9A and 9B, and the PMT information according to the second exemplary embodiment has been described with reference to FIGS. 10A and 10B, but if a first ES loop, a second ES loop, and a third ES loop are inserted according to a hierarchical or parallel structure, types, orders, definitions, and usage examples of parameters or information inserted into each PMT information may vary.

3D additional information may include information for indicating whether 2D video data or 3D video data is inserted into a current ES. For example, Table 3 below shows 2D/3D mode information (‘2d/3d_mode’) and Table 4 below shows 2D/3D mode switch notice information (‘notice_indicator’).

TABLE 3

| 2d/3d_mode | Description |
|---|---|
| 01 | 2D Video |
| 00 | 3D Video |
| 10 | 2D/3D Composite Video |

The 2D/3D mode information (‘2d/3d_mode’) indicates whether video data inserted into a current ES is a 2D video, a 3D video, or a 2D/3D composite video. The 2D/3D composite video is a video stream, in which a 2D video and a 3D video are mixed with each other, and the 2D and 3D videos may be transmitted or received together through one channel. The apparatus 100 may insert the 2D/3D mode information into the PMT information so as to transmit information indicating that any one of the 2D video, the 3D video, and the 2D/3D composite video is inserted into current video data. The apparatus 200 may predict which one of the 2D video, the 3D video, and the 2D/3D composite video will be extracted from a video data stream received through one channel, based on the 2D/3D mode information extracted from the PMT information.

TABLE 4

| notice_indicator | Description |
|---|---|
| 1 | Switched |
| 0 | No Switch |

The 2D/3D mode switch notice information (‘notice_indicator’) indicates whether video data in a current ES is switched from 2D video data to 3D video data. The apparatus 100 may insert the 2D/3D mode switch notice information into the PMT information to indicate whether the video data in the current ES is switched from the 2D video data to the 3D video data. The apparatus 200 may predict whether currently received video data is switched between 2D video data and 3D video data based on the 2D/3D mode switch notice information extracted from the PMT information.

The PMT generator 120 of the apparatus 100 may insert the 2D/3D mode information and the 2D/3D mode switch notice information into a reserved region of the PMT information. The PMT additional information extractor 230 of the apparatus 200 may extract the 2D/3D mode information and the 2D/3D mode switch notice information from the reserved region of the PMT information. The apparatus 200 may determine which video data and related additional information is to be parsed and extracted from a current ES by using the 2D/3D mode information and the 2D/3D mode switch notice information.

The 2D/3D mode information and the 2D/3D mode switch notice information are selectively inserted into the PMT information according to first and second exemplary embodiments according to a purpose.

3D stream descriptor information (‘3D_stream_Descriptor’) of Table 5 and view arrangement order information (‘LR_first’) of Table 6 correspond to 3D additional information inserted into the PMT information according to the first exemplary embodiment.

TABLE 5
Syntax

```
3D_stream_Descriptor{
  descriptor_tag
  descriptor_length
  Main_Video_format
  LR_first
  num_of_sub_stream
  for( i=0; i<num_of_sub_stream; i++){
    sub_stream_type
    sub_video_PID
    sub_video_Format
    if ( sub_video_Format == 3D ){
      picture_display_order
      sub_view_info
    }else{
      sub_view_index
    }
  }
}
```

The 3D stream descriptor information (‘3D_stream_Descriptor’) of Table 5 may be inserted into the descriptor information 915 and 954 which is inserted into the first video ES loops 910 and 955 described above with reference to FIGS. 9A and 9B. In the 3D stream descriptor information of Table 5, a for loop may correspond to a sub ES loop, i.e., the second video ES loops 920 and 970 of FIGS. 9A and 9B. 3D additional information about a main ES may be inserted into the 3D stream descriptor information, and 3D additional information about a sub ES may be inserted into the sub ES loop.

The PMT generator 120 according to the first exemplary embodiment may insert at least one of image format information (Main_Video_format) of main video data, view arrangement order information (LR_first) in an image format of the main video data, and information (num_of_sub_stream) about a number of sub ESs into the 3D additional information as information for identifying and reproducing the 3D video data according to views. The number of sub ES loops inserted into the 3D stream descriptor information may be determined according to the information about the number of sub ESs, and the 3D additional information may be inserted into each sub ES loop.

The PMT generator 120 according to the first exemplary embodiment may insert at least one of stream type information (sub_stream_type) of a sub ES, PID information (sub_video_PID) of the sub ES, image format information (sub_video_Format) of sub view video data, display order information (picture_display_order) of main view video data and the sub view video data, information (sub_view_info) for adjusting a 3D effect for a child or an adult, and sub view index information (sub_view_index) indicating the sub view video data in the 3D video data into the PMT information, as the 3D additional information.

The view arrangement order information (LR_first) may indicate which region is a left view image and a right view image from a 3D composite format of a current ES. Referring to Table 6, a format arrangement order may define locations of a left view image and a right view image in the 3D composite format of FIG. 7.

TABLE 6

| | LR_first = 0 | | LR_first = 1 | |
|---|---|---|---|---|
| Identification | Left View | Right View | Left View | Right View |
| Vertical Line Interleaved Format | Odd Line | Even Line | Even Line | Odd Line |
| (Parallax Barrier Format) | | | | |
| Horizontal Line Interleaved Format | Odd Line | Even Line | Even Line | Odd Line |
| Top and Bottom Format | Upper Side | Lower Side | Lower Side | Upper Side |
| Side by Side Format | Left Side | Right Side | Right Side | Left Side |
| Field Sequential Format | Odd Field | Even Field | Even Field | Odd Field |
| Frame Sequential Format | Odd Frame | Even Frame | Even Frame | Odd Frame |
| Two ESs | Main Media | Sub Media | Sub Media | Main Media |

When a value of ‘LR_first’ is 0, left view video data is disposed on a left region of a side-by-side format image, an upper region of a top-and-bottom format, an odd numbered line of a vertical line interleaved format, an odd numbered line of a horizontal line interleaved format, an odd numbered parameter of a field sequential format, or an odd numbered frame of a frame sequential format. Also, when current 3D video data is inserted into two ESs and the value of ‘LR_first’ is 0, the left view video data may be main view video data (Main media) of a first ES of the two ESs. Accordingly, right view video data may be arranged in a region opposite of where the left view video data is disposed in each 3D composite format described above.

When a value of ‘LR_first’ is 1, the arrangement of the right view video data and the left view video data may be the opposite of the arrangement when the value of ‘LR_first’ is 0.

The PMT additional information extractor 230 of the apparatus 200 may read the 3D stream descriptor information of Table 5, and extract 3D additional information about a main ES from the descriptor information 915 and 954 in the first video ES loops 910 and 955. Also, the PMT additional information extractor 230 may extract 3D additional information about a sub ES from the sub ES loop in the 3D stream descriptor information. Accordingly, the ES restorer 240 may accurately restore 3D video data by using the 3D additional information about the main ES and the sub ES, and the reproducer 250 may reproduce the 3D video data.

Various types of 3D additional information or 3D sub descriptors that may be inserted into the PMT information according to the second exemplary embodiment described with reference to FIGS. 10A and 10B are shown in Tables 7 through 20.

The PMT generator 120 of the apparatus 100 may insert 3D descriptor information (‘3d_descriptor’) of Table 7 below into the descriptor information 1015 and 1053 in the first video ES loops 1010 and 1055 described above with reference to FIGS. 10A and 10B.

TABLE 7
Syntax

```
3d_descriptor{
  num_of_ES
  if ( num_of_ES == 1 ){
    1ES_format
    LR_first
    ...
  }else if ( num_of_ES == 2){
    Multi_ES_format
    ...
  }else if( num_of_ES == 3){
    Multi_ES_format
    ...
  }
}
```

The 3D descriptor information (‘3d_descriptor’) of Table 7 describes different information about a 3D video according to information (‘num_of_ES’) about the number of ESs into which video data of each view of a 3D video is inserted. When video data of each view is inserted into one ES, the 3D descriptor information may describe the 3D composite format information (1ES_format) described in FIG. 7, and the view arrangement order information (LR_first) described in Table 6. Alternatively, when the video data of each view is inserted into at least two ESs, the 3D descriptor information may describe the 3D hybrid format information (Multi_ES_format) described in FIG. 8.

Even when only the descriptor information 1015 and 1053 in the first video ES loop 1010 and 1055 is parsed and read from the PMT information according to the second exemplary embodiment, the PMT additional information extractor 230 of the apparatus 200 may predict not only the 3D additional information about the first video ES, but also the 3D image format of the sub video data inserted into the sub ES.

The PMT generator 120 of the apparatus 100 may insert auxiliary video stream descriptor information (‘Auxiliary_video_stream_descriptor( )’) of Table 8 below into the descriptor information 1025, 1035, 1063, and 1073 of the second and third video ES loops 1020, 1030, 1060, and 1070 described above with reference to FIGS. 10A and 10B.

TABLE 8
Syntax

```
Auxiliary_video_stream_descriptor( ) {
  descriptor_tag
  descriptor_length
  aux_video_codedstreamtype
  si_rbsp(descriptor_length−1)
}
```

The auxiliary video stream descriptor information (Auxiliary_video_stream_descriptor) may include information (‘aux_video_codestreamtype) about a method of encoding sub video data.

The PMT generator 120 may insert 3D additional information into ‘si_rbsp (descriptor_length-1)’ information.

In detail, the PMT generator 120 may insert the 3D additional information into ‘si_payload’ in ‘si_message’ information in ‘si_rbsp’ information in the auxiliary video stream descriptor information of Table 9. Tables 9, 10, and 11 respectively show the ‘si_rbsp’ information, the ‘si_message’ information, and ‘si_payload’ information in the auxiliary video stream descriptor information.

TABLE 9
Syntax

```
si_rbsp( NumBytesInSI ) {
  NumBytesInRBSP = 0
  while( NunBytesInRBSP < NumBytesInSI)
    si_message( )
}
```

TABLE 10
Syntax

```
si_message( ) {
  ...
    NumBytesInRBSP ++
    payloadSize += last_payload_size_byte
    si_payload( payloadType, payloadSize)
    NumBytesInRBSP += payloadSize
}
```

TABLE 11
Syntax

```
si_payload( payloadType, payloadSize){
  is_avsi = FALSE
  if( payloadType == 0 || payloadType == 1 || payloadType == 2 ){
    is_avsi = TRUE
    generic_params( )
  }
  if( payloadType == 0 )
    depth_params( )
  else if ( payloadType == 1 )
    parallax_params( )
  else if ( payloadType == 2 )
    additional_view_param( )
  else
    reserved_si_message ( payloadType, payloadSize )
}
```

The PMT generator 120 adds a sub view video data (‘Additional view’) item to a depth map (‘Depth map’) and a parallax map (‘Parallax map’), as payload type information for a sub ES as shown in Table 12.

TABLE 12

| payloadType | Type of Auxiliary Video |
|---|---|
| 0 | Depth Map |
| 1 | Parallax Map |
| 2 | Additional_view |
| Other Values | Reserved |

For 3D additional information that is used when payload type information for an ES having a current auxiliary video stream type is sub view video data (‘payloadType==2’), the PMT generator 120 may change content of ‘generic_params( )’ information in the ‘si_payload’ information of Table 10 as shown in Table 13, and newly add ‘additional_view_params( )’ information of Table 16.

First, the PMT information 120 inserts information (‘hybrid_indicator’) indicating whether current 3D video data is a hybrid format, and information (‘hybrid_type’) about a type of the hybrid format into the ‘generic_params( )’ information of Table 13.

TABLE 13
Syntax

```
generic_params( ){
  aux_is_one_field
  if (aux_is_one_field){
    aux_is_bottom_field
  }
  else{
    aux_is_interlaced
  }
  hybrid_indicator
  hybrid_type
  reserved_generic_bits
  position_offset_h
  position_offset_v
}
```

TABLE 14

| Value | hybrid_indicator |
|---|---|
| 0 | Hybrid typed format not used |
| 1 | Hybrid typed format used |

TABLE 15

| Value | hybrid_type |
|---|---|
| 000 | Sub view image |
| 001 | Depth information |
| 010 | Sub view image + depth information |
| 011 | Sub view image |
| 100 | Parallax information |
| 101 | Sub view image + parallax information |
| 110 | Reserved |

The PMT additional information extractor 230 of the apparatus 200 may extract hybrid format indicator information (‘hybrid_indicator’) from the sub stream descriptor information (‘Auxiliary_video_stream_descriptor’) about the sub ES in the PMT information, and the reproducer 250 may predict whether the 3D video data inserted into the current ES is a 3D hybrid format according to Table 14, based on the extracted hybrid format indicator information.

Alternatively, the PMT additional information extractor 230 may extract hybrid format type information (‘hybrid_type’) from the sub stream descriptor information, and the reproducer 250 may determine a type of a hybrid format of the sub video data of the sub ES according to Table 15, based on the extracted hybrid format type information.

For 3D additional information that is used when the payload type information of the ES of the sub ES type is the sub view video data (‘payloadType==2’), the PMT generator 120 may further insert ‘additional_view_params( )’ information of Table 16 into the sub video descriptor information.

TABLE 16
Syntax

```
additional_view_params( ){
  linked_PID
  LR_indicator
}
```

The PMT generator 120 may further insert PID information (‘linked_PID’) of another piece of video data related to the sub video data of the current sub ES, and information (‘LR_indicator’) indicating whether the sub video data is a left view video or a right view video into the ‘additional_view_params( )’ information, so as to form 3D video data.

TABLE 17

| Value | linked_PID |
|---|---|
| 0x0000~0x1FFF | Value of PID of main view related to sub view |

TABLE 18

| Value | LR_indicator |
|---|---|
| 0 | Indicate that corresponding sub view image is L |
| 1 | Indicate that corresponding sub view image is R |

The PMT additional information extractor 230 of the apparatus 200 may extract the sub view parameter of Table 16 from the sub stream descriptor information about the sub ES in the PMT information.

The PMT additional information extractor 230 extracts the PID information ‘linked_PID’ in the sub view parameter (‘additional_view_params( )’), and the reproducer 250 may check PID information about a packet or a stream into which the current sub video data and the another piece of video data are inserted, based on the extracted PID information ‘linked_PID’. The PID information ‘linked_PID’ may indicate main view video data related to the current sub video data, according to Table 17.

The PMT additional information extractor 230 may extract the information ‘LR_indicator’ in the sub view parameter (‘additional_view_params( )’), and the reproducer 250 may determine whether the sub video data of the current sub ES is left view video data or right view video data in a stereo video according to Table 18, based on the extracted information ‘LR_indicator’.

Alternatively, the PMT generator 120 may further insert sub view video resolution information (‘additional_view_resolution’) into the sub view parameter (‘additional_view_params( )’), besides the PID information ‘linked_PID’ and the information ‘LR_indicator’ according to Table 19.

TABLE 19
Syntax

```
additional_view_params( ){
  linked_PID
  LR_indicator
  additional_view_resolution
}
```

TABLE 20

| Value | additional_view_resolution |
|---|---|
| 0b00 | 1920 × 1080 |
| 0b01 | 1280 × 720 |
| 0b10 | 704 × 480 |
| 0b11 | 640 × 480 |

The PMT additional information extractor 230 may extract the sub view video resolution information (‘additional_view_resolution’) in the sub view parameter (‘additional_view_params( )’), and the reproducer 250 may determine a size of the sub view video data of a transmission format according to Table 20. The reproducer 250 may compare a size of main view video data and a size of the sub view video data in the transmission format, and may adjust the sizes of the main and sub view video data while changing the transmission format to a reproduction format.

The PMT generator 120 of the apparatus 100 may further insert 3D mode descriptor information (‘3d_mode_descriptor( )’) of Table 21, and 3D notice descriptor information (‘3d_notice_descriptor( )’) of Table 22 into the PMT information, as the 3D additional information, besides the 3D stream descriptor information (‘3d_stream Descriptor( )’) or the 3D video descriptor information (‘3d_descriptor( )’) including information about characteristics of 3D video data.

The PMT generator 120 may insert the 2D/3D mode information (‘2d/3d_mode’) and the 2D/3D mode switch notice information (‘notice_indicator’) into the 3D mode descriptor information (‘3d_mode_descriptor( )’). The PMT generator 120 may insert 3D icon indicator information (‘es_icon_indicator’), switch indicator information (‘transition_indicator’), switching time stamp information (‘transition_time_stamp’), and switch message information (‘transition_message’) into the 3D notice descriptor information (‘3d_notice_descriptor( )’).

TABLE 21
Syntax

```
3D_mode_descriptor( ){
  descriptor_tag
  descriptor_lendgth
  2d/3d_mode
  notice_indicator
}
```

The PMT additional information extractor 230 of the apparatus 100 extracts the 3D mode descriptor information (‘3d_mode_descriptor( )’) from a descriptor region of a program loop or an ES loop in the PMT information, and may extract the 2D/3D mode information (‘2d/3d_mode’) and the 2D/3D mode switch notice information (‘notice_indicator’). The reproducer 250 of the apparatus 200 may determine a switch between a 2D mode and a 3D mode of video data of a current program or a current ES, based on the extracted 3D mode descriptor information, the 2D/3D mode information, and the 2D/3D mode switch notice information.

TABLE 22
Syntax

```
3D_notice_descriptor( ){
  descriptor_tag
  descriptor_lendgth
  es_icon_indicator
  transition_indicator
  if(transition_indicator == 1){
    transition_time_stamp
    transition_message
  }
}
```

The PMT additional information extractor 230 of the apparatus 200 may extract the 3D notice descriptor information (‘3d_notice_descriptor( )’) from the descriptor region of the program loop or ES loop in the PMT information.

The PMT additional information extractor 230 may extract the 3D icon indicator information (‘es_icon_indicator’) in the 3D notice descriptor information (‘3d_notice_descriptor( )’), and the reproducer 250 may determine that a 3D related icon, such as a 3D notice indicator, is provided by a content provider, and display the 3D notice indicator in such a way that the 3D notice indicator does not overlap with a 3D notice indicator of a set-top box or a television (TV), based on the extracted 3D icon indicator information (‘es_icon_indicator’). For example, when a value of the 3D icon indicator information (‘es_icon_indicator’) is 0, it may be determined that a 3D notice icon does not exist in a video ES, and thus the 3D notice indicator of the set-top box or the TV is used, and when the value of the 3D icon indicator information (‘es_icon_indicator’) is 1, it may be determined that the 3D notice icon exists in the video ES, and thus one of the 3D notice icon in the video ES and the 3D notice indicator of the set-top box and TV may be used.

The PMT additional information extractor 230 may extract the switch indicator information (‘transition_indicator’) in the 3D notice descriptor information (‘3d_notice_descriptor( )’), and the reproducer 250 may determine whether PMT information to be received includes 2D/3D mode information indicating that a mode of the PMT information to be received is different from a current mode obtained from current PMT information, i.e., whether the mode of the PMT information to be received is to be changed. For example, when a value of the switch indicator information (‘transition_indicator’) is 0, the current mode is maintained in a video ES, and when the value of the switch indicator information (‘transition_indicator’) is 1, the current mode may be switched.

When the switch indicator information indicates that a 2D/3D switch is to be generated (‘transition_indicator==1’), the PMT additional information extractor 230 extracts switching time stamp information (‘transition_time_stamp’) from the 3D notice descriptor information (‘3d_notice_descriptor( )’) and the reproducer 250 may determine a point of time when the 2D/3D mode switch is to be generated. The switching time stamp information may be expressed in units of presentation time stamps (PTSs). The switching time stamp information may be expressed as a relative value between a PTS value of a picture image including the current PMT information and a PTS value at a point of time when the 2D/3D switch is to be generated, or an absolute value of the PTS value at the point of time when the 2D/3D mode switch is to be generated. However, the switching time stamp information may be expressed in other units, such as units of the number of frames, besides the unit of PTSs.

When the switch indicator information indicates that the 2D/3D switch is to be generated (‘transition_indicator==1’), the PMT additional information extractor 230 may extract switch message information (‘transition_message’) from the 3D notice descriptor information (‘3d_notice_descriptor( )’). The reproducer 250 of the apparatus 200 may determine a visual effect, such as an icon or a text, or an auditory effect, such as sound, which is a 2D/3D mode switch notice indicator, while reproducing a content service based on the extracted switch message information. A user may recognize that the current mode will be switched through the 2D/3D mode switch notice indicator, or if the 2D/3D mode is to be switched, may pre-prepare to change a viewing mode.

FIG. 11 illustrates an example of using mode conversion information according to an exemplary embodiment.

Parts of a current video stream 1100 from a 2D image sequence 1102 to a 3D image sequence 1136 are illustrated in FIG. 11, wherein the current video stream 1100 includes 2D image sequences 1102 through 1128, and 3D image sequences 1130 through 1136.

The apparatus 100 transmits PMT information 1140, 1150, and 1160 about the current video stream 1100 respectively at points of time T1, T2, and T3. Since 2D/3D mode information (2D/3D_mode) in the PMT information 1140 at the point of time T1 indicates 2D, current video data is in a 2D mode. However, 2D/3D mode information (2D/3D_mode) in the PMT information 1150 at the point of time T2 indicates 2D, but 2D/3D mode switch information (transition_time_stamp) indicates the point of time T3. In other words, the current video data is in the 2D mode, but may switch to a 3D mode in the current video stream 1100.

As indicated in the 2D/3D mode switch information (transition_time_stamp) in the PMT information 1150 at the point of time T2, the 2D/3D mode switch is generated at the point of time T3, and 2D/3D mode information (2D/3D_mode) of the PMT information 1160 at the point of time T3 indicates 3D. The apparatus 200 may determine a mode at the points of time T1, T2, and T3, and a point of time when the 2D/3D mode switch is to be generated by using the 2D/3D mode switch information of the PMT information 1140, 1150, and 1160, and may display the 2D/3D mode switch notice message on a screen or audibly reproduce the 2D/3D mode switch notice message at a predetermined point of time between the points of time T2 and T3, according to the 2D/3D mode switch notice indicator information (‘transition_message’).

The apparatus 100 may transmit a main view video and a sub view video having different resolutions. For example, the apparatus 100 may transmit main view video data at a full high definition (HD) level and sub view video data at a standard definition (SD) level.

FIG. 12 illustrates an example when a left view video and a right view video are transmitted in different sizes according to an exemplary embodiment.

The apparatus 100 may obtain a left view video 1210 and a right view video 1220, which are at a full HD level and have a size of 1920×1080, and convert and transmit a data stream, into which left view video data 1230 that is at a full HD level and has a size of 1920×1080 and right view video data 1240 that is at a SD level and has a size of 640×480 are inserted, into a TS as a transmission format.

The apparatus 200 receives the TS, and the ES restorer 240 of the apparatus 200 may restore the left view video data 1230 and the right view video data 1240. Even when the reproducer 250 expands the left and right view video data 1230 and 1240 to convert formats of the left and right view video data 1230 and 1240 into a reproduction format, widths and lengths of the left and right view video data 1230 and 1240 are not the same since an aspect ratio of the left view video data 1230 is 16:9, and an aspect ratio of the right view video data 1240 is 4:3. In other words, left view video 1250 that is at a full HD level and has the reproduction format, and right view video 1260 enlarged to 1440×1080 and having the reproduction format may both have the same lengths of 1080 pixels, but different widths, i.e., the left view video 1250 is 1920 and the right view video is 1440. If resolutions of a main view video and a sub view video are not the same, it may be difficult to generate a 3D effect while reproducing a 3D video.

FIG. 13 illustrates an example of using aspect ratio information according to an exemplary embodiment.

The reproducer 250 may restore the left view video 1250 that is at the full HD level and has the reproduction format, and restore the right view video having the reproduction format enlarged from the transmission format. Here, if the left view and right view videos 1250 and 1260 are reproduced as they are, regions 1350 and 1360 of the left view video 1250, in which the right view video 1260 is not displayed, may be generated.

Accordingly, the apparatus 100 includes aspect ratio information as 3D additional information, for a case when resolutions of a main view video and a sub view video are not the same. The PMT generator 120 of the apparatus 100 may insert aspect ratio information (‘3d_aspect_ratio_descriptor’) into PMT information, as the 3D additional information, and insert cropping offset information (‘cropping_offset’) as the aspect ratio information (‘3d_{—aspect}_ratio_descriptor’) as shown in Table 23 below. For example, information about a width of a region in a main view video, which is not covered by an enlarged sub view video, may be set as the cropping offset information (‘cropping_offset’), and the cropping offset information (‘cropping_offset’) may be inserted into the PMT information, as the 3D additional information.

TABLE 23
Syntax

```
3d_aspect_ratio_descriptor{
  descriptor_tag
  descriptor_length
  cropping_offset
}
```

The PMT additional information extractor 230 of the apparatus 200 may extract the aspect ratio information (‘3d_aspect_ratio_descriptor’) from the PMT information, and extract the cropping offset information (‘cropping_offset’) in the aspect ratio information (‘3d_aspect_ratio_descriptor’). The reproducer 250 may reproduce a left view video and a right view video, which have aspect ratios of 4:3, by cropping the regions 1350 and 1360 in the left view video 1250 having a size of 1920×1080, which are not covered by the right view video 1260 having a size of 1440×1080 in the center of the left view video 1250, based on the cropping offset information (‘cropping_offset’). Alternatively, the reproducer 250 may generate a 3D effect in a center region having a size of 1440×1080 by displaying the left view video 1250 in the regions 1350 and 1360, and alternatively displaying the left view video 1250 and the right view video 1260 in the center region covered by the right view video 1260.

The apparatus 100 may convert 2D or 3D video data to TSs, by inserting PID information about the packets into PMT information, and inserting the 3D additional information of Tables 1 through 23 above into a program loop, an ES loop, in which stream type information is ‘video_stream_type’ or ‘auxiliary_video_stream_type’, and various reserved regions, in the PMT information, and transmit the TS.

When a receiver complying with an MPEG TS method supports only a 2D video, 3D additional information, 3D descriptor information, and 3D stream descriptor information in PMT information according to an exemplary embodiment are unable to be parsed and interpreted while the receiver parses and decodes a received data stream. Accordingly, a packet including the 3D video data is not detected, and thus the receiver only recognizes and decodes 2D video data set in the MPEG TS method, and descriptor information about the 2D video data. Thus, the receiver may process data related to a 2D video in a data stream generated by the apparatus 100.

The apparatus 200 may extract PMT information by receiving a TS and gathering packets including PID information of the PMT information, and the PMT additional information extractor 230 may extract and transmit 3D additional information from a program loop, an ES loop, and various reserved regions of the PMT information to the reproducer 250.

Also, the apparatus 200 may gather payloads of packets having ‘video_stream_type’ as stream type information in PMT information so that the ES restorer 240 restores video data based on PID information of the packets.

Also, the apparatus 200 may gather payloads of packets having ‘Auxiliary_video_stream_type’ as stream type information so that the ES restorer 240 restores sub video data based on PID information of the packets.

The reproducer 250 of the apparatus 200 restores main view video and sub view video by analyzing a 3D composite format or 3D hybrid format of main video data and sub video data extracted from a main ES and sub ES, reproduces the main view video and the sub view video while synchronizing reproduction periods of the main view video and the sub view video, which are mutually related to each other, by using 3D additional information in the PMT information.

Operations of the reproducer 250 will now be described in detail.

When the ES restorer 240 extracts a main view video as main video data, and sub view video as sub video data, the reproducer 250 may form reproduction formats of the main view video and the sub view video to be reproducible by a 3D display device and output the main and sub view videos.

When the ES restorer 240 extracts a main view video as main video data, and a difference image as sub video data, the reproducer 250 may restore a sub view video by using the main view video and the difference image, form reproduction formats of the main view video and the sub view video to be reproducible by a 3D display device, and output the main and sub view videos.

When the ES restorer 240 extracts a main view video as main video data, and depth information (or parallax information) and a sub view video as one or two pieces of sub video data, the reproducer 250 may generate an intermediate view video by using the main view video, the sub view video, and the depth information (or parallax information). For example, the intermediate view video may be generated based on the main view video and the depth information by using a depth image based rendering (DIBR) method. The reproducer 250 may select two view videos from among the main view video, the intermediate view video, and the sub view video, form reproduction formats of the two selected view videos to be reproducible by a 3D display device, and output the two view videos. When there is a large depth difference or parallax between the main view video and the sub view video, the intermediate view video may be used to prevent viewing fatigue.

When the ES restorer 240 extracts 3D composite format data as main video data, the reproducer 250 may restore a main view video and a sub view video from the 3D composite format data, form reproduction formats of the main and sub view videos to be reproducible by a 3D display device, and output the main and sub view videos.

When the ES restorer 240 extracts 3D composite format data as main video data and depth information (or parallax information) as sub video data, the reproducer 250 may restore a main view video and a sub view video from the 3D composite format data, and generate an intermediate view video by using the main view video, the sub view video, and the depth information (or parallax information). For example, the intermediate view video may be generated by applying a DIBR method to the main view video, the sub view video, and the depth information (or parallax information). Two view videos may be selected from among the main view video, the intermediate view video, and the sub view video, and reproduction formats of the two view videos may be formatted to be reproducible by a 3D display device before being output.

When the ES restorer 240 extracts 3D composite format data as main video data and difference information as sub video data, the reproducer 250 may restore a main view video and a sub view video, which have a resolution that is half that of the original resolution, based on the 3D composite format data. Here, the reproducer 250 may restore the main view video and the sub view video having the same resolution as the original resolution, by additionally using the difference information on the main and sub view videos having the half resolution. The reproducer 250 may form reproduction formats of the main view video and the sub view video to be reproducible by a 3D display device, and output the main and sub view videos.

When the ES restorer 240 extracts a 2D video as main video data, and depth information (or parallax information) as sub video data, the reproducer 250 may restore a sub view video by using the 2D video and the depth information (or parallax information), form reproduction formats of the main view video and the sub view video to be reproducible by a 3D display device, and output the main and sub view videos. However, if the sub view video forming a complete 3D video with the main view video is not restored, an occlusion phenomenon may occur.

When the ES restorer 240 extracts a first view video forming a multi view video as main video data, and a plurality of other view videos, such as a second view video and a third view video forming a multi view video, as a plurality of pieces of sub video data, the reproducer 250 may format reproduction formats of the plurality of other view videos to be reproducible by a 3D display device based on the first view video, and output the plurality of other view videos. Unlike a stereo video, a multi view video may provide a 3D video viewable while rotating 360°.

When the ES restorer 240 extracts a first video forming a multi photographed video as main video data, and a plurality of other videos, such as a second video and a third video, as sub video data, the reproducer 250 may selectively and individually output each of the first through third videos or output the first through third videos in a picture-in-picture (PIP) method. For example, a method of displaying videos that are photographed in various locations and directions under one theme, such as a first video photographed in a catcher's view, a second video photographed in a pitcher's view, and a third video of bleachers in a baseball match, may be changed based on a viewer or a purpose of broadcasting, unlike in the case of a multi view video.

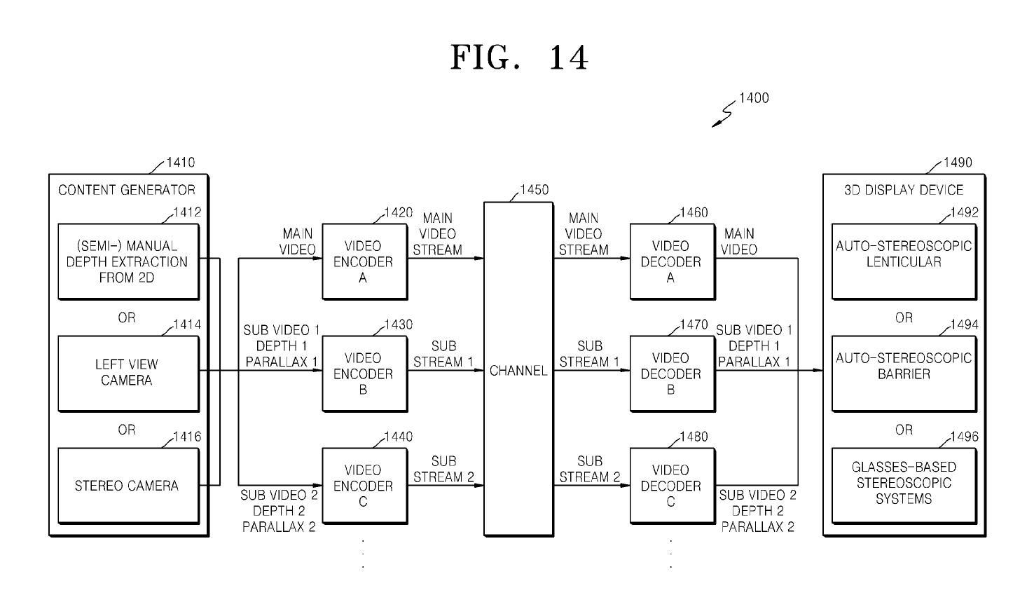

FIG. 14 is a block diagram of a system 1400 for communicating a 3D video data stream, according to an exemplary embodiment, in which the apparatus 100 and the apparatus 200 are realized.

A content generator 1410 of a transmitter may generate video data about content by using one of various photographing methods, such as (semi-) manual depth extraction from 2D 1412, an RGB+ infrared camera 1414, or a stereo camera 1416.

From among the video data of the content generator 1410, main video data MAIN VIDEO may be output to a video encoder A 1420, at least one of first sub video data SUB VIDEO 1, first depth information DEPTH 1, and first parallax information PARALLAX 1 may be output to a video encoder B 1430, and at least one of second sub video data SUB VIDEO 2, second depth information DEPTH 2, and second parallax information PARALLAX 2 may be output to a video encoder C 1440.

The video encoder A 1420, the video encoder B 1430, and the video encoder C 1440 may encode received video data, and respectively output a main video stream MAIN VIDEO STREAM, a first sub stream SUB VIDEO STREAM 1, and a second sub stream SUB VIDEO STREAM 2 to a channel 1450.

TSs of the main video stream MAIN VIDEO STREAM, the first sub stream SUB VIDEO STREAM 1, and the second sub stream SUB VIDEO STREAM 2 are transmitted to a receiver, and the receiver may demultiplex the TSs and transmit video packets to a video decoder A 1460, a video decoder B 1470, and a video decoder C 1480.

The video decoder A 1460 may restore and output main video from the main video stream MAIN VIDEO STREAM, the video decoder B 1470 may restore and output at least one of the first sub video data SUB VIDEO 1, the first depth information DEPTH 1, and the first parallax information PARALLAX 1 from the first sub stream SUB VIDEO STREAM 1, and the video decoder C 1480 may restore and output at least one of the second sub video data SUB VIDEO 2, the second depth information DEPTH 2, and the second parallax information PARALLAX 2 from the second sub stream SUB VIDEO STREAM 2.

The restored main video, the restored first sub video data SUB VIDEO 1, first depth information DEPTH 1, and first parallax information PARALLAX 1, and the restored second sub video data SUB VIDEO 2, second depth information DEPTH 2, and second parallax information PARALLAX 2 may be transmitted to a 3D display device 1490, where each are converted suitably according to a display method, and reproduced in 3D. For example, a restored 3D video may be reproduced in 3D by the 3D display device 1490 by using one of various methods, such as an auto-stereoscopic lenticular method 1492, an auto-stereoscopic barrier method 1494, or a glasses-based stereoscopic system 1496.

Accordingly, the apparatus 100 may insert 3D additional information, such as main video data, first sub data, and second sub data having a 3D hybrid format, into PMT information, and transmit the PMT information. Also, the apparatus 200 may extract the 3D additional information from the PMT information in a received data stream, and determine that the 3D additional information, such as the main video data, the first sub data, and the second sub data having the 3D hybrid format, is inserted into a payload of the received data stream. In addition, after extracting the 3D additional information from the payload, the apparatus 200 may restore a main view video and a sub view video using the 3D additional information, and reproduce the main and sub view videos in 3D by using a 3D display device.

FIG. 15 is a flowchart illustrating a method of generating a data stream for providing a 3D multimedia service, according to an exemplary embodiment.

In operation 1510, at least one ES including video data of each view in a program for providing a 2D or 3D multimedia service is generated. ESs about audio data and sub data in the program may also be generated.

In operation 1520, PMT information about the program, including reference information about the at least one ES and 3D additional information for identifying and reproducing the video data of each view according to views is generated. At least one of the 3D additional information and the reference information may be inserted into descriptor information about a corresponding ES in the PMT information. According to a structure of PMT information according to the first exemplary embodiment, 3D additional information about a main ES in the PMT information may include at least one of 3D additional information and reference information about a sub ES. According to a structure of PMT information according to the second exemplary embodiment, the PMT information may sequentially include ES information of each of the at least one ES, and each piece of the ES information includes at least one of 3D additional information and reference information about a corresponding ES.

The 3D additional information may include 2D/3D notice information indicating that a current video packet includes 2D or 3D video data, 3D descriptor information for restoring and reproducing a 3D video, 2D/3D mode switch information indicating a current mode of a current program and 2D/3D mode switch in the future, and aspect ratio information.

In operation 1530, TSs are generated by PES packets generated by packetizing the at least one ES, and the PMT information. The TSs may each include a payload and a heater, and sections of the PES packets or the PMT information may be included in the payload. The TSs may be transmitted through at least one channel.

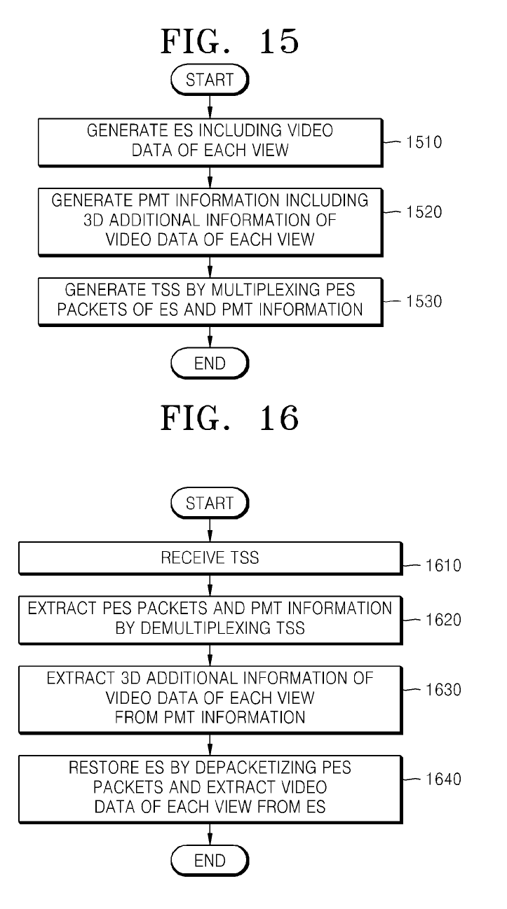

FIG. 16 is a flowchart illustrating a method of receiving a data stream for providing a 3D multimedia service, according to an exemplary embodiment.

In operation 1610, TSs about a program for providing a 2D or 3D multimedia service are received.

In operation 1620, PES packets about the program and PMT information about the program are extracted by demultiplexing the TSs.

In operation 1630, reference information and 3D additional information about ESs of video data of each view in the program are extracted from the PMT information. According to a structure of PMT information according to the first exemplary embodiment, at least one of 3D additional information and reference information about a sub ES may be extracted from 3D additional information about a main ES in the PMT information. According to a structure of PMT information according to the second exemplary embodiment, 3D sub descriptor information may be extracted from ES information about a sub ES or ES information about a main ES, and 3D additional information and reference information about a sub ES may be extracted from the 3D sub descriptor information.

In operation 1640, the at least one ES is restored by using the extracted reference information about the at least one ES from among ESs extracted by depacketizing the PES packets, and the video data of each view is extracted from the at least one ES.

By restoring the video data of each view by using the 3D additional information and the reference information, and reproducing the video data of each view by synchronizing reproduction periods and reproduction orders of the video data of each view according to views, a 3D multimedia service may be provided to a viewer.

According to the method of transmitting a data stream, according to an exemplary embodiment, various types of 3D additional information and reference information may be transmitted together with a 2D video and a 3D video by using an ES having a related art stream type, without having to add a stream type of an ES into which 3D video data is inserted, based on an MPEG TS system. For example, a stream type of a main ES may comply with an MPEG-2 standard or an MPEG-4/AVC, and a stream type of a sub ES may comply with an MPEG-2 standard or an MPEG-4/AVC standard, or may be an auxiliary video stream.

Since a receiving system that does not support an auxiliary video stream is unable to recognize a sub ES, the receiving system may determine a current video service as a 2D video service by recognizing only a main ES. Accordingly, even when existing related art receiving system receives a TS generated according to a method of generating a data stream, according to an exemplary embodiment, video data may be analyzed according to operations of the related art receiving system to be reproduced in 2D. Thus, inverse compatibility may be maintained.

According to a method of receiving a data stream, according to an exemplary embodiment, when not only main view video data and sub view video data, but also depth information and parallax information are additionally received through a TS about one program received through one channel, the main and sub view video data, the depth information, and the parallax information are restored to reproduce not only a stereo video but also a multi view video. Here, 3D additional information and reference information extracted from PMT information are used to accurately restore and reproduce the multi view video.

Exemplary embodiments can be written as computer programs and can be implemented in general-use digital computers that execute the programs by using a computer readable recording medium. Examples of the computer readable recording medium include storage media, such as magnetic storage media (e.g., ROM, floppy disks, hard disks, etc.) and optical recording media (e.g., CD-ROMs, or DVDs). Moreover, one or more units of the above-described apparatuses can include a processor or microprocessor executing a computer program stored in a computer-readable medium.

While exemplary embodiments have been particularly shown and described above, it will be understood by those of ordinary skill in the art that various changes in form and details may be made therein without departing from the spirit and scope of the inventive concept as defined by the appended claims. The exemplary embodiments should be considered in descriptive sense only and not for purposes of limitation. Therefore, the scope of the inventive concept is defined not by the detailed description of the exemplary embodiments, but by the appended claims, and all differences within the scope will be construed as being included in the present inventive concept.

What is claimed is:

1. A method of generating a data stream for providing a three-dimensional (3D) multimedia service, the method comprising:
generating at least one elementary stream comprising video data of each view from a program for providing at least one of a two-dimensional (2D) multimedia service and a 3D multimedia service;
generating program map table information about the program, comprising reference information about the generated at least one elementary stream and 3D additional information for identifying and reproducing the video data of each view; and
generating at least one transport stream by multiplexing packetized elementary stream packets generated by packetizing the generated at least one elementary stream, and the generated program map table information.

2. The method of claim 1, wherein the generating the program map table information comprises:
inserting 3D additional information about main video data, which is inserted in a main elementary stream from among the generated at least one elementary stream, into descriptor information for the main elementary stream in the program map table information; and
inserting at least one of 3D additional information and reference information about sub video data included in a sub elementary stream from among the generated at least one elementary stream, into the descriptor information for the main elementary stream,
wherein the main video data and the sub video data are a combination of video data of first and second views, respectively.

3. The method of claim 2, wherein the 3D additional information about the main video data comprises at least one of image format information of the main video data, view arrangement order information of an image format of the main video data, and information about a number of sub elementary streams corresponding to the main elementary stream.

4. The method of claim 3, wherein:
the 3D additional information about the main video data further comprises reference information about the sub elementary stream; and
the reference information about the sub elementary stream comprises at least one of stream type information of the sub elementary stream and packet identifier information of the sub elementary stream.

5. The method of claim 2, wherein the 3D additional information about the sub video data comprises at least one of image format information of the sub video data of the sub elementary stream, display order information of the main video data and the sub video data, 3D effect adjustment information for a child or an adult, and sub video index information indicating the sub video data from the video data of each view.

6. The method of claim 1, wherein the generating the program map table information comprises sequentially inserting elementary stream information, which comprises stream type information, packet identifier information, and video stream descriptor information of a respective elementary stream, into the program map table information, according to the at least one generated elementary stream.

7. The method of claim 6, wherein the generating the program map table information further comprises inserting, into the program map table information, 3D video descriptor information, which comprises 3D additional information about main video data included in a main elementary stream from the at least one generated elementary stream.

8. The method of claim 7, wherein the inserting the 3D video descriptor information comprises inserting information about a number of the generated at least one elementary stream and image format information of the generated at least one elementary stream into the 3D video descriptor information.

9. The method of claim 8, wherein:
if the number of the at least one elementary stream is one, the image format information of the generated at least one elementary stream indicates a 3D composite format in which main view video data and sub view video data from the video data of each view are composed; and
if the number of the at least one generated elementary stream is two or greater, the image format information of the at least one generated elementary stream indicates a 3D image format in which the video data of each view comprises the main view video data and at least one of depth information of the sub view video data with respect to the main view video data, parallax information of the sub view video data with respect to the main view video data, and the sub view video data.

10. The method of claim 6, wherein the generating the program map table information further comprises inserting sub elementary stream video descriptor information comprising the 3D additional information into the elementary stream information about a sub elementary stream from among the generated at least one elementary stream.

11. The method of claim 10, wherein the inserting the sub elementary stream video descriptor information comprises inserting, into the sub elementary stream video descriptor information, information indicating whether at least one of depth information and parallax information of sub view video data with respect to main view video data is simultaneously transmitted with the sub view video data, and 3D hybrid format information.

12. The method of claim 10, wherein the inserting the sub elementary stream video descriptor information comprises inserting, into the sub video descriptor information, information indicating whether sub video data is at least one of sub view video data and depth or parallax information of the sub view video data.

13. The method of claim 12, wherein the inserting the sub elementary stream video descriptor information further comprises, if the sub video data is the sub view video data, inserting, into the sub elementary stream video descriptor information, a sub view video parameter comprising at least one of packet identifier information about a main view elementary stream related to the sub elementary stream, and information indicating whether the sub video data is left view video data or right view video data.

14. The method of claim 6, wherein the inserting the elementary stream information comprises setting the stream type information of the elementary stream information about the sub elementary stream to a value of an auxiliary video stream assigned by a Moving Picture Experts Group system.

15. The method of claim 10, wherein the inserting the sub elementary stream video descriptor information comprises, if a number of sub elementary streams is two or more, setting the sub elementary stream video descriptor information according to each sub elementary stream.

16. The method of claim 1, wherein the generating the program map table information comprises inserting 3D notice descriptor information indicating whether the 3D video data is included in the generated at least one transport stream, into the program map table information.

17. The method of claim 16, wherein the 3D notice descriptor information comprises at least one of information indicating whether a 3D notice indicating icon indicating that the 3D video data is included in a current elementary stream exists, 2D/3D mode switch information indicating whether mode information different from current mode information of current program map table information is included in following program map table information after the current program map table information, switching time stamp information indicating a point of time when a 2D mode and a 3D mode are switched, and text information comprising a message to be displayed on a screen when the 2D mode and the 3D mode are switched.

18. The method of claim 1, wherein the generating the program map table information comprises inserting, into the program map table information, 2D/3D transmission information comprising at least one of 2D/3D mode information indicating whether any one of the 2D video data, the 3D video data, and combined data of the 2D and 3D video data is included in a current elementary stream, and 2D/3D mode switch information indicating whether the 2D/3D mode information of current program map table information is switched in following program map table information after the current program map table information.

19. The method of claim 1, wherein the generating the program map table information comprises, if at least one of sizes and aspect ratios of main view video data and sub view video data from the video data of each view are different, inserting, into the program map table information, aspect ratio descriptor information comprising cropping offset information about a method of adjusting regions for displaying the main view video data and the sub view video data during 3D reproduction.

20. The method of claim 1, further comprising transmitting the transport streams after synchronizing the transport streams with a channel.

21. A method of receiving a data stream for providing a three-dimensional (3D) multimedia service, the method comprising:
receiving at least one transport stream about a program providing at least one of a two-dimensional (2D0 multimedia service and a 3D multimedia service;
extracting packetized elementary stream packets about the program and program map table information about the program by demultiplexing the at least one transport stream;
extracting, from the program map table information, reference information about at least one elementary stream comprising video data of each view of the program, and 3D additional information for identifying and reproducing the video data of each view; and
restoring the at least one elementary stream by using the extracted reference information about the at least one elementary stream from among elementary streams extracted by depacketizing the packetized elementary stream packets, and extracting the video data of each view from the restored at least one elementary stream.

22. The method of claim 20, further comprising reproducing the extracted video data of each view in 3D by using the extracted 3D additional information.

23. The method of claim 21, wherein the extracting the reference information and the 3D additional information from the program map table information comprises:
extracting, from the program map table information, at least one of reference information about a main elementary stream from among the at least one elementary stream, and 3D additional information about main video data included in the main elementary stream from descriptor information for the main elementary stream; and
extracting, from the descriptor information for the main elementary stream, at least one of reference information about a sub elementary stream from among the at least one elementary stream, and 3D additional information about sub video data included in the sub elementary stream,
wherein the main video data and the sub video data are a combination of video data of first and second view, respectively.

24. The method of claim 23, wherein the 3D additional information about the main view video data comprises at least one of image format information of the main video data, view arrangement order information in an image format of the main video data, and information about a number of sub elementary streams corresponding to the main elementary stream.

25. The method of claim 24, wherein:
the 3D additional information about the main view video data further comprises reference information about the sub elementary stream; and
the reference information about the sub elementary stream comprises at least one of stream type information of the sub elementary stream and packet identifier information of the sub elementary stream.

26. The method of claim 23, wherein the 3D additional information about the sub video data comprises at least one of image format information of the sub video data, display order information of the main video data and the sub video data, 3D effect adjustment information for a child or an adult, and sub video index information indicating the sub video data from the video data of each view.

27. The method of claim 21, wherein the extracting the reference information and the 3D additional information from the program map table information comprises sequentially extracting elementary stream information, which comprises stream type information, packet identifier information, and video stream descriptor information of a respective elementary stream, from the program map table information, according to the at least one elementary stream.

28. The method of claim 27, wherein the extracting the reference information and the 3D additional information from the program map table information further comprises extracting 3D video descriptor information, which comprises 3D additional information about the video data of each view, from the elementary stream information about a main view elementary stream comprising main view video data from among the video data of each view in the at least one elementary stream.

29. The method of claim 28, wherein the extracting the 3D video descriptor information comprises extracting, from the 3D video descriptor information, information about a number of the at least one elementary stream, and image format information of the at least one elementary stream.

30. The method of claim 29, wherein:
if the number of the at least one elementary stream is one, the image format information of the at least one elementary stream indicates a 3D composite format in which main view video data and sub view video data from the video data of each view are composed; and
if the number of the at least one elementary stream is two or greater, the image format information of the at least one elementary stream indicates a 3D image format in which the video data of each view comprises the main view video data and at least one of depth information of the sub view video data with respect to the main view video data, parallax information of the sub view video data with respect to the main view video data, and the sub view video data.

31. The method of claim 27, wherein the extracting the reference information and the 3D additional information from the program map table information further comprises extracting sub elementary stream video descriptor information comprising the 3D additional information from the elementary stream information about the sub elementary stream from among the at least one elementary stream.

32. The method of claim 31, wherein the extracting the sub elementary stream video descriptor information comprises extracting, from the sub elementary stream video descriptor information, information indicating whether at least one of depth information and parallax information of the sub view video data with respect to the main view video data is simultaneously transmitted with the sub view video data, and 3D hybrid format information.

33. The method of claim 31, wherein the extracting the sub elementary stream video descriptor information comprises extracting, from the sub elementary stream video descriptor information, information indicating whether sub video data is at least one of sub view video data and depth or parallax information of the sub view video data.

34. The method of claim 33, wherein the extracting the sub elementary stream video descriptor information further comprises, if the sub video data is the sub view video data, extracting, from the sub elementary stream video descriptor information, a sub view video parameter comprising at least one of packet identifier information about a main view elementary stream related to the sub view elementary stream, and information indicating whether the sub video data is left view video data or right view video data.

35. The method of claim 27, wherein, in the extracting the elementary stream information, the stream type information of the elementary stream information about the sub elementary stream is set to a value of an auxiliary video stream assigned by a Moving Picture Experts Group system.

36. The method of claim 31, wherein the extracting the sub elementary stream video descriptor information comprises, if a number of sub elementary streams is two or more, extracting the sub elementary stream video descriptor information according to each sub elementary stream.

37. The method of claim 21, wherein the extracting the reference information and the 3D additional information from the program map table information comprises extracting, from the program map table information, 3D notice descriptor information indicating whether the 3D video data is included in the at least one transport stream.

38. The method of claim 37, wherein the 3D notice descriptor information comprises at least one of information indicating whether a 3D notice indicating icon indicating that the 3D video data is included in a current elementary stream exists, 2D/3D mode switch information indicating whether mode information different from current mode information of current program map table information is included in following program map table information after the current program map table information, switching time stamp information indicating a point of time when a 2D mode and a 3D mode are switched, and text information comprising a message to be displayed on a screen when the 2D mode and the 3D mode are switched.

39. The method of claim 37, wherein the extracting the reference information and the 3D additional information from the program map table information comprises extracting, from the program map table information, 2D/3D transmission information comprising at least one of 2D/3D mode information indicating whether any one of the 2D video data, the 3D video data, and combined data of the 2D and 3D video data is included in a current elementary stream, and 2D/3D mode switch information indicating whether the 2D/3D mode information of current program map table information is switched in following program map table information after the current program map table information.

40. The method of claim 21, wherein the extracting the reference information and the 3D additional information from the program map table information comprises, if at least one of sizes and aspect ratios of main view video data and sub view video data from the video data of each view are different, extracting, from the program map table information, aspect ratio descriptor information comprising cropping offset information about a method of adjusting regions for displaying the main view video data and the sub view video data during 3D reproduction.

41. The method of claim 22, wherein the reproducing comprises:
restoring main view video data and sub view video data of 3D video of the 3D multimedia service; and
reproducing the main view video data and the sub view video data by converting formats of the main view video data and the sub view video data into 3D reproduction formats so as to be reproducible by a 3D display device, by using the 3D additional information.

42. The method of claim 22, wherein the reproducing comprises:
restoring first view video data, which is one of main view video data of 3D video of the 3D multimedia service and 2D video data, and second view video data, which comprises sub view video data of the 3D video and at least one of difference information, depth information, and parallax information between the main view video data and the sub view video data; and
reproducing the first view video data and the second view video data by converting formats of the first view video data and the second view video data into 3D reproduction formats so as to be reproducible by a 3D display device, by using the 3D additional information.

43. The method of claim 22, wherein the reproducing comprises:
restoring first view video data constituting 3D composite format data in which main view video data and sub view video data of 3D video of the 3D multimedia service are composed, and second view video data constituting one of difference information, depth information, and parallax information between the main view video data and the sub view video data; and
reproducing the first view video data and the second view video data by converting formats of the first view video data and the second view video data into 3D reproduction formats so as to be reproducible by a 3D display device, by using the 3D additional information.

44. The method of claim 42, wherein:
the restoring comprises generating intermediate view video data of the main view video data and the sub view video data by using the first view video data and the second view video data; and
the reproducing the first view video data and the second view video data comprises reproducing the first view video data, the intermediate view video data, and the second view video data by converting formats of the first view video data, the intermediate view video data, and the second view video data into 3D reproduction formats by using the 3D additional information.

45. The method of claim 22, wherein the reproducing comprises:
restoring a plurality of pieces of 2D video data forming 3D video; and
reproducing the restored plurality of pieces of 2D video data selectively or in a picture-in-picture reproduction mode, by using the 3D additional information.

46. The method of claim 40, further comprising:
reproducing the extracted video data of each view in 3D by using the 3D additional information by decoding and restoring the extracted video data of each view,
wherein the reproducing comprises cropping a region of the main view video data exceeding the sub view video data based on the cropping offset information in the aspect ratio descriptor information, and reproducing the extracted video data of each view in 3D by using the cropped main view video data and the sub view video data.

47. The method of claim 40, further comprising:
reproducing the extracted video data of each view in 3D by using the 3D additional information by decoding and restoring the extracted video data of each view,
wherein the reproducing comprises:
generating extended sub view video data by filling a region of the sub view video data, which is smaller than the main view video data, with respective main view video data based on the cropping offset information in the aspect ratio descriptor information; and
reproducing the extracted video data of each view in 3D by using the main view video data and the extended sub view video data.

48. An apparatus for generating a data stream for providing a 3-dimensional (3D) multimedia service, the apparatus comprising:
an elementary stream generator which generates at least one elementary stream comprising video data of each view from a program for providing at least one of a two-dimensional (2D) multimedia service and a 3D multimedia service;
a program map table generator for generating program map table information about the program, comprising reference information about the generated at least one elementary stream and 3D additional information for identifying and reproducing the video data of each view;
a transport stream generator which generates at least one transport stream by multiplexing packetized elementary stream packets generated by packetizing the generated at least one elementary stream, and the generated program map table information; and
a channel transmitter which synchronizes and transmits the generated at least one transport stream with a channel.

49. An apparatus for receiving a data stream for providing a 3D multimedia service, the apparatus comprising:
a transport stream receiver which receives at least one transport stream about a program providing at least one of a 2D multimedia service and a 3D multimedia service;
a transport stream demultiplexer which extracts packetized elementary stream packets about the program and program map table information about the program by demultiplexing the at least one transport stream;
a program map table 3D additional information extractor which extracts, from the program map table information, reference information about at least one elementary stream comprising video data of each view of the program, and 3D additional information for identifying and reproducing the video data of each view;
an elementary stream restorer which restores the at least one elementary stream by using the extracted reference information about the at least one elementary stream from among elementary streams extracted by depacketizing the packetized elementary stream packets, and extracts the video data of each view from the restored at least one elementary stream; and
a reproducer which decodes and restores the extracted video data of each view and reproducing the restored video data of each view in 3D by using at least one of the 3D additional information and the reference information.

50. A computer readable recording medium having recorded thereon a program for executing the method of claim 1.

51. A computer readable recording medium having recorded thereon a program for executing the method of claim 21.
